(19) United States
(12) Patent Application Publication
(10) Pub. No.: US 2025/0312633 A1
(43) Pub. Date: Oct. 9, 2025

(54) ACCESS FACILITATION CONDUIT

(71) Applicant: MANDERSON ENGINEERING INNOVATIONS PTY LTD, Sydney, New South Wales (AU)

(72) Inventors: Sarah BATTENALLY, Sydney, New South Wales (AU); James MANDERSON, Lyons, Northern Territory (AU)

(21) Appl. No.: 18/865,315

(22) PCT Filed: May 11, 2023
(86) PCT No.: PCT/AU2023/050395

§ 371 Date: Nov. 12, 2024

(30) Foreign Application Priority Data
May 11, 2022 (AU) 2022901255

(51) Int. Cl. A62C 31/22; A62C 31/28; F16L 5/04

(52) U.S. Cl. CPC A62C 31/22; A62C 31/28; F16L 5/04

(57) ABSTRACT

An access facilitation conduit or deck box is mountable on a barrier such as a bulkhead or a container vessel. The deck box allows for the insertion of the firefighting accessory such as a nozzle to a pre-established aperture in the deck box. The deck box is ordinarily sealed in the aperture a rupturable membrane or disc. The insertion of the firefighting accessory through the deck box ruptures the rupturable membrane. The deck box further allows for the provision of sensors as well as a feed of electronic data out through the deck box to a ship wide control and monitoring system. Sensors can detect fire, explosion, humidity, temperature, and the like. A firefighting accessory is for use with the deck box, as well as penetration assistance mechanisms for facilitating the penetration of the rupturable membrane.

### FIELD OF THE INVENTION

The present invention relates to an access facilitation conduit, and in particular to an access facilitation conduit for use with a firefighting accessory on vessels that define compartmented spaces.

The invention has been developed primarily for use in/application on water craft and similar vessels and will be described hereinafter with reference to this application. However, it will be appreciated that the invention is not limited to this particular field of use.

### BACKGROUND OF THE INVENTION

At present, if a fire breaks out in a particular compartment on a vessel at sea, then extinguishing the fire can be extremely hazardous, as access to the fire may be limited, and because heat can build up in enclosed spaces very quickly. Opening up of hatches to the compartment in which the fire is present may be hazardous, as this could feed oxygen to the fire, causing an escalation of the fire, also known as backdraft.

At present, one of the methodologies used to fight fires within a compartment on a vessel includes cutting through the bulkhead from an adjacent area, such as a passageway or adjacent room. Cutting of the bulkhead may be carried out by oxyacetylene gas torch, or using some other exothermic cutting process, to cut a hole in the typically steel bulkhead. Firefighters then try and spray firefighting chemicals or water through the aperture in the bulkhead. However, making an aperture in the bulkhead using an oxyacetylene torch or exothermic process may present its own risks. The oxyacetylene torch may cause the ignition of the highly volatile gases that accumulate above the fire within the compartment. Further, the use of oxyacetylene torches may cause additional items to be set alight within the fire zone.

Another methodology is to drill a hole into the bulkhead from the adjacent area to connect a firefighting accessory to the bulkhead and dispense firefighting agent into the fire affected compartment. However, the operator may be at risk of drilling into structural steel, meaning that it will take a long time to drill through the bulkhead, or, the operator may inadvertently drill into critical electrical cables, or drill into the wrong part of the bulkhead.

The present invention seeks to provide an access facilitation conduit, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect, the present invention may be said to involve an access facilitation conduit for allowing access by a firefighting accessory through a barrier at least partially surrounding a compartment, the access facilitation conduit comprising:
a. a frame adapted to be mounted within the aperture of the deck, the frame defining a passage therethrough; and
b. a rupturable membrane retainable by the frame to at least partially cover the passage, the rupturable membrane being configured for being ruptured to access the passage.

In one embodiment, the frame is cylindrical.

In one embodiment, the access facilitation conduit includes a clamping arrangement for clamping the rupturable membrane in position.

In one embodiment, the clamping arrangement includes an annular seat for seating the rupturable membrane.

In one embodiment, the annular seat is integrally formed with the frame.

In one embodiment, the clamping arrangement includes an inner annular retaining formation configured to retain the rupturable membrane.

In one embodiment, the annular seat and the inner annular retaining formation are configured to retain the rupturable membrane between them.

In one embodiment, the inner annular retaining formation and the annular seat are castellated.

In one embodiment, the rupturable membrane is a single-use membrane.

In one embodiment, the rupturable membrane is a burst disc or a rupture disk.

In one embodiment the inner annular retaining formation and the seat are configured to be held together by fasteners.

In one embodiment, the rupturable membrane is integrally formed with the frame.

In one embodiment, the access facilitation conduit includes a cover arrangement.

In one embodiment, the cover arrangement includes a closure member.

In one embodiment, the closure member is removably attachable to the frame.

In one embodiment, the frame is removably attachable to the deck of a marine vessel.

In one embodiment, the frame is permanently attachable to the deck of a marine vessel.

In one embodiment, the frame is configured to sealingly engage with a firefighting accessory.

In one embodiment, the inner annular retaining formation is configured to sealingly engage with the firefighting accessory.

In one embodiment, the access facilitation conduit includes a temperature sensor.

In one embodiment, the access facilitation conduit includes a nozzle arrangement configured for extending through the aperture in the barrier.

In one embodiment, the access facilitation conduit includes a connector arrangement for connecting to a source of fire extinguishing agent.

In one embodiment, the rupturable membrane is configured to be ruptured by the pressure of the fire extinguishing agent.

In one embodiment, the access facilitation conduit includes a frame connecting arrangement configured for connecting the frame to the barrier.

In one embodiment, the frame connecting arrangement includes a threaded formation on the frame and a retaining ring.

In one embodiment, the access facilitation conduit includes a primary rupturable membrane and a secondary rupturable membrane.

In one embodiment, the primary rupturable membrane is configured for rupturing and very high pressures, and has a primary purpose of sealing the passage through the access facilitation conduit in the event of water ingress into the compartment.

In one embodiment, the secondary rupturable membrane is configured for sensing a high-pressure event such as an explosion in the compartment.

In one embodiment, the secondary rupturable membrane includes a bimetallic sensor for sensing when the rupturable membrane has burst.

In one embodiment, the access facilitation conduit includes a firefighting accessory connector thread by which the firefighting accessory can be turned to move through the passage and penetrate the one or more rupturable membranes.

In one embodiment, the access facilitation conduit includes at least one or more sensors for sensing one or more selected from:
a. temperature;
b. humidity;
c. pressure;
d. pH;
e. light; and
f. any other characteristic.

In one embodiment, the at least one or more sensors of located on the compartment side of the access facilitation conduit.

In one embodiment, the access facilitation conduit includes a transmitter.

In one embodiment, the access facilitation conduit includes a receiver.

In one embodiment, the access facilitation conduit includes an electrical terminal that can be connected to electrical circuitry.

In one embodiment, the electrical terminal is located to be accessible from outside of the compartment.

In one embodiment, the access facilitation conduit includes an electrical connector arrangement configured for connecting the at least one or more sensors on the compartment side of the access facilitation conduit is to the electrical terminal through one or more selected from the frame and the clamping arrangement.

In one embodiment, the transmitter is configured for transmitting data received from the one or more sensors.

In one embodiment, the access facilitation conduit includes a quick connector mechanism adapted for allowing convenient quick connection of the firefighting accessory.

In one embodiment, the quick connector mechanism is configured for capturing the firefighting accessory by locking it in position when it is inserted into the quick connector mechanism.

In one embodiment, the quick connector mechanism includes an outer sleeve, an inner annular member, and at least one or more spherical members.

In one embodiment, the outer sleeve is spring biased by a spring.

In one embodiment, the inner annular member defines an outer face and an inner face.

In one embodiment the inner annular member includes a tapered aperture configured to seat a ball bearing within the tapered aperture.

In one embodiment, the spherical member is movable between a seated position in which it is seated in the tapered aperture to extend inwardly of the inner face of the inner annular member, and an unseated position in which the spherical member does not extend inwardly of the inner face of the inner annular member.

In one embodiment, the spring biased outer sleeve is movable between a locked condition in which it locks the spherical member in its seated position and an unlocked condition in which the spherical member is able to move to an unseated position.

In one embodiment, the outer sleeve is manually movable between a locked condition and its unlocked condition.

In one embodiment, the outer sleeve is spring biased to its locked condition.

In one embodiment, the spring biased outer sleeve is manually movable between its locked condition and unlocked condition by manually pushing the spring biased outer sleeve against the spring bias.

In one embodiment, the quick connector mechanism includes a retaining circlip for retaining the spherical member.

According to a further aspect, the present invention may be said to involve an access facilitation conduit for allowing access by a firefighting accessory through a barrier at least partially surrounding a compartment, the access facilitation conduit comprising:
a. a frame adapted to be mounted within the aperture of the barrier, the frame defining a passage therethrough; and
b. a nozzle attached to the frame and in fluid communication with the passage;
c. an agent connector arrangement configured for connection to a source of fire extinguishing agent to thereby allow the flow of fire extinguishing agent through the passage; and
d. a cover retainable by the frame to at least partially cover the passage, the cover being configured for removal to allow access to the connector arrangement.

In one embodiment, the access facilitation conduit includes a rupturable membrane retainable by the frame to at least partially cover the passage.

In one embodiment, the rupturable membrane is configured for being ruptured to access the passage.

In one embodiment, the frame is cylindrical.

In one embodiment, the frame includes an annular formation to retain the cover.

In one embodiment, the cover is hingedly connected to the frame.

In one embodiment, the frame is removably attachable to the deck of a marine vessel.

In one embodiment, the frame is permanently attachable to the deck of a marine vessel.

In one embodiment, the access facilitation conduit includes a temperature sensor.

According to a further aspect, the present invention may be said to involve an access facilitation conduit for use with a barrier with an aperture through which access can be provided into a compartment, the access facilitation conduit comprising:
a. an electrically insulative body member defining a passage therethrough, the insulated body member being configured for receiving fire extinguishing agent to thereby allow the flow of fire extinguishing agent through the passage; and
b. a retaining arrangement adapted to attach to the body member and securely mount the body member within the aperture of the barrier.

In one embodiment, the access facilitation conduit includes a rupturable membrane retainable by the insulated body member to at least partially cover the passage.

In one embodiment, the rupturable membrane is configured for being ruptured to access the passage.

In one embodiment, the body member is configured for connection to a source of fire extinguishing agent

In one embodiment, the body member is substantially cylindrical.

In one embodiment, the body member includes an outer insulative piece and an inner insulative piece.

In one embodiment, the retaining arrangement includes an inner retaining member and an outer retaining member.

In one embodiment, the retaining arrangement includes a body retaining member retaining configured for retaining the body member in position together with the outer retaining member.

In one embodiment, the inner retaining member and outer retaining member are configured for attachment to each other through the aperture.

In one embodiment, the inner retaining member and outer retaining member are configured for attachment to each other by complementary threaded fastening formations.

In one embodiment, the body retaining member and outer retaining member are configured for attachment to each other by complementary threaded fastening formations.

In one embodiment, the body retaining member and outer retaining member are configured for locating the body member through the body retaining member and outer retaining member in operation.

In one embodiment, the inner insulative piece and the outer insulative piece each include an engaging formation configured to engage a complementary engaging formation on the retaining arrangement.

In one embodiment, the inner insulative piece and the outer insulative piece each include an engaging formation configured to engage a complementary engaging formation on the body retaining member and outer retaining member, respectively.

In one embodiment, the inner insulative piece and the outer insulative piece are configured to retain the rupturable membrane between them.

In one embodiment, the access facilitation conduit includes a clamping arrangement for clamping the rupturable membrane in position.

In one embodiment the engagement of the body retaining member with the outer retaining member act to clamp the inner insulative piece and the outer insulative piece together to retain the rupturable membrane.

In one embodiment, access facilitation conduit includes a seal between the inner insulative piece and the outer insulative piece.

In one embodiment, access facilitation conduit includes a seal between the inner insulative piece and the outer retaining member.

In one embodiment, the insulative body member is made from a non-conductive material.

In one embodiment, the insulative body member is made from a temperature resistant material.

In one embodiment, the insulative body member is made from a ceramic material.

In one embodiment, the inner insulative piece includes a nozzle configured to dispense fire extinguishing agent.

In one embodiment, the inner insulative piece includes connecting formations for connecting to a source of fire extinguishing agent.

In one embodiment, the connecting formations are threaded connecting formations.

According to a further aspect, the present invention may be said to involve a method for providing access to a space adjacent a deck on a marine vessel, the method comprising the step of:
a. accommodating the access facilitation conduit described above within an aperture of the deck.

According to a further aspect, the present invention may be said to involve a penetration assistance mechanism for penetrating a rupturable membrane on an access facilitation conduit (“deck box”), the penetration assistance mechanism comprising:
a. an accessory connecting formation adapted for engaging with a firefighting accessory for penetrating through a barrier to access a compartment in which a fire may be present;
b. a base configured for secure connection to one or more selected from the access facilitation conduit and the barrier;
c. a force application mechanism configured for applying force to carry out one or more selected from:
   i. pushing the firefighting accessory at least partially through a rupturable membrane of the deck box; and
   ii. rupturing the rupturable membrane to allow access by the firefighting accessory through the rupturable membrane.

In one embodiment, the force application mechanism is a force multiplier mechanism configured for multiplying one or more selected from force and pressure applied to the force multiplier mechanism to carry out one or more selected from:
a. pushing the firefighting accessory at least partially through a rupturable membrane of the deck box; and
b. rupturing the rupturable membrane to allow access by the firefighting accessory through the rupturable membrane.

In one embodiment, the force multiplier mechanism is configured for pushing the firefighting accessory through a pair of rupturable membranes.

In one embodiment, the base includes deck box connecting formations configured for mounting the penetration assistance mechanism to complementary connecting formations on the access facilitation conduit.

In one embodiment, the deck box connecting formations include a recessed flange configured for extending at least partially into one or more selected from a channel and a lip on the deck box, to thereby prevent movement of the penetration assistance mechanism in an opposed direction to the direction the firefighting accessory is being pushed through the rupturable membrane.

In one embodiment, the force multiplier mechanism is one or more selected from
a. a hydraulic force multiplier mechanism; and
b. a mechanical force multiplier mechanism.

In one embodiment, the mechanical force multiplier mechanism includes one or more selected from a lever and a threaded formation.

In one embodiment, the hydraulic force multiplier mechanism is a manual hydraulic force multiplier mechanism.

In one embodiment, the hydraulic force multiplier mechanism is configured for utilising the pressure of firefighting agent to carry out one or more selected from
a. rupturing the rupturable membrane; and
b. pushing the firefighting accessory at least partially through the rupturable membrane.

In one embodiment, the hydraulic force multiplier mechanism includes a manual lever mechanism.

In one embodiment the hydraulic force multiplier mechanism is configured for translating manual effort on the manual lever mechanism into hydraulic pressure.

In one embodiment, the mechanical force multiplier mechanism is configured for translating helical movement along a thread formation to axial movement.

In one embodiment, the mechanical force multiplier mechanism includes a rotatable member that includes a thread formation that is configured for engagement with a complementary thread formation on an access facilitation conduit to thereby move the rotatable member in an axial direction.

In one embodiment, the mechanical force multiplier mechanism includes an abutment member for abutting with an abutment formation on a firefighting accessory to thereby drive the firefighting accessory through a passage in the access facilitation conduit.

In one embodiment, the penetration assistance mechanism includes extinguishing agent connector formations for connecting the penetration assistance mechanism to a source of pressurised fire extinguishing agent.

According to a further aspect, the present invention may be said to involve an access facilitation conduit including a penetration assistance mechanism described.

According to a further aspect, the present invention may be said to involve a firefighting accessory configured for coupling with an access facilitation conduit as described.

According to a further aspect, the present invention may be said to involve a firefighting accessory configured for coupling with a penetration assistance mechanism as described.

According to a further aspect, the present invention may be said to involve a firefighting accessory for insertion through an access facilitation conduit into a compartment in which a fire may be present, the firefighting accessory comprising:
a. an annular body member including a conduit for guiding the passage of firefighting agent;
b. a quick coupling connection formation for connecting to a complementary quick coupling connection formation on an access facilitation conduit; and
c. connecting formations for connecting to a source of fire extinguisher agent.

In one embodiment, the firefighting accessory includes a nozzle.

In one embodiment, the annular body member is a hollow tube.

In one embodiment, the annular body member defines an inner face and an outer face.

In one embodiment, the quick coupling connection formation includes a recess in the outer face.

In one embodiment, the recess extends at least partially around the periphery of the annular body member.

In one embodiment, the firefighting accessory includes a cutting accessory extending past the nozzle.

In one embodiment, the cutting accessory is a cap.

In one embodiment, the cap extends over the nozzle.

In one embodiment, the cutting accessory is configured for cutting a rupturable membrane in an access facilitation conduit.

In one embodiment, the cutting accessory is one or more selected from annular and cylindrical.

In one embodiment, the outer diameter of the cutting accessory corresponds with the inner diameter of the access facilitation conduit.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

Other aspects of the invention are also disclosed.

### BRIEF DESCRIPTION OF THE DRAWINGS

Notwithstanding any other forms which may fall within the scope of the present invention, a preferred embodiments of the invention will now be described, by way of example only, with reference to the accompanying drawings in which:

FIG. 1 shows an exploded top perspective view of an access facilitation conduit according to a first embodiment where the rupturable membrane is in tact;

FIG. 2 shows an exploded bottom perspective view of the access facilitation conduit shown in FIG. 1;

FIG. 3 shows a shows an exploded section view of the access facilitation conduit shown in FIGS. 1 and 2;

FIG. 4 shows an in-use perspective view of the access facilitation conduit shown in FIG. 1 installed on a bulkhead of a vessel, together with a close up view;

FIG. 5 shows a section view of the installed access facilitation conduit shown in FIG. 4, together with a close up view;

FIG. 6 shows an exploded top perspective view of an access facilitation conduit when the rupturable membrane is ruptured;

FIG. 7 shows an exploded bottom perspective view of the access facilitation conduit shown in FIG. 6;

FIG. 8 shows an exploded section view of the access facilitation conduit shown in FIGS. 6 and 7;

FIG. 9 shows an in-use perspective view of the access facilitation conduit shown in FIG. 6 installed on a bulkhead of a vessel, together with a close up view;

FIG. 10 shows a section view of the installed access facilitation conduit shown in FIG. 9, together with a close up view;

FIG. 11 shows an in-use isometric view of the access facilitation conduit shown in FIG. 6 installed on a shipping container, together with a close up section side view;

FIG. 12 shows an in-use side view of the access facilitation conduit installed on a shipping container shown in FIG. 6, together with a close up section side view;

FIG. 13 shows an exploded top perspective view of an access facilitation conduit according to a second embodiment where the rupturable membrane is in tact;

FIG. 14 shows an exploded section view of the access facilitation conduit shown in FIG. 13;

FIG. 15 shows an assembled section view of the access facilitation conduit shown in FIG. 13;

FIG. 16 shows an exemplary castellated pattern;

FIG. 17 shows an exploded top perspective view of the access facilitation conduit shown in FIG. 13 where the rupturable membrane is ruptured;

FIG. 18 shows an exploded section view of the access facilitation conduit shown in FIG. 17;

FIG. 19 shows an assembled section view of the access facilitation conduit shown in FIG. 17;

FIG. 20 shows an exploded top perspective view of an access facilitation conduit according to a third embodiment;

FIG. 21 an exploded bottom perspective view of an access facilitation conduit shown in FIG. 20;

FIG. 22 shows an exploded section view of the access facilitation conduit shown in FIG. 20;

FIG. 23 shows an assembled top perspective view of the access facilitation conduit shown in FIG. 20;

FIG. 24 shows an assembled bottom perspective view of the access facilitation conduit shown in FIG. 20;

FIG. 25 shows an assembled side view of the access facilitation conduit shown in FIG. 20;

FIG. 26 shows an assembled section view of the access facilitation conduit shown in FIG. 20;

FIG. 27 shows an exploded top perspective view of an access facilitation conduit according to a fourth embodiment;

FIG. 28 shows an exploded bottom perspective view of the access facilitation conduit shown in FIG. 27;

FIG. 29 shows an exploded section view of the access facilitation conduit shown in FIG. 27;

FIG. 30 shows a assembled top perspective view of the access facilitation conduit shown in FIG. 27;

FIG. 31 shows an assembled bottom perspective view of the access facilitation conduit shown in FIG. 27

FIG. 32 shows an assembled side view of the access facilitation conduit shown in FIG. 27;

FIG. 33 shows an assembled section view of the access facilitation conduit shown in FIG. 27;

FIG. 34 shows a section view of an access facilitation conduit according to a fifth embodiment;

FIG. 35 shows a perspective section view of the access facilitation conduit shown in FIG. 34;

FIG. 36 shows a perspective view of the access facilitation conduit shown in FIG. 34;

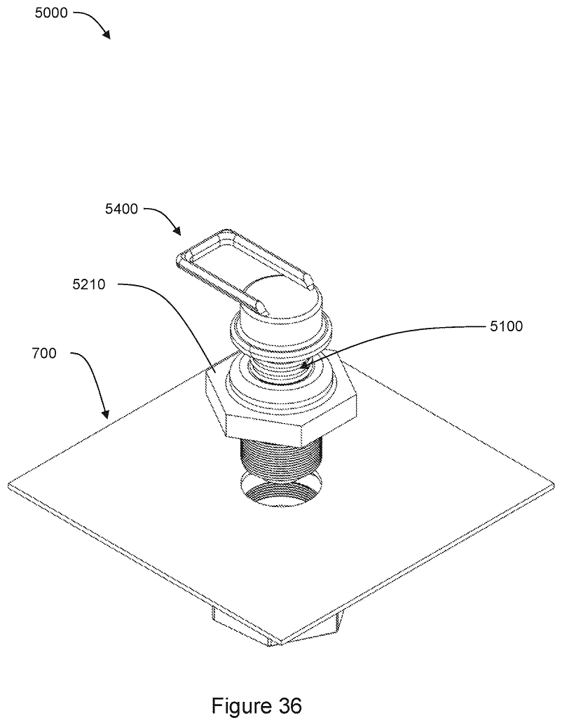

FIG. 37 shows a cutaway perspective view of an access facilitation conduit according to a sixth embodiment;

FIG. 38 shows a perspective view of the access facilitation conduit of FIG. 37 connected to a transceiver;

FIG. 39 shows a cross-section plan view of the access facilitation conduit of FIG. 38;

FIG. 40 shows a bottom perspective view of the access facilitation conduit of FIG. 39 without connected sensors;

FIG. 41 shows a cutaway top perspective view of an access facilitation conduit according to a seventh embodiment;

FIG. 42 shows an exploded cutaway view of the access facilitation conduit of FIG. 41;

FIG. 43 shows an exploded assembly side view of the access facilitation conduit of FIG. 41;

FIG. 44 shows a cutaway exploded assembly's side view of the access facilitation conduit of FIG. 41;

FIG. 45 shows a top perspective view of the access facilitation conduit of FIG. 41;

FIG. 46 shows a top view of the access facilitation conduit of FIG. 41;

FIG. 47 shows a cutaway side view of the access facilitation conduit of FIG. 1 with a firefighting accessory inserted and locked in position;

FIG. 48 shows a top perspective view of FIG. 47;

FIG. 49 shows a side view of FIG. 47;

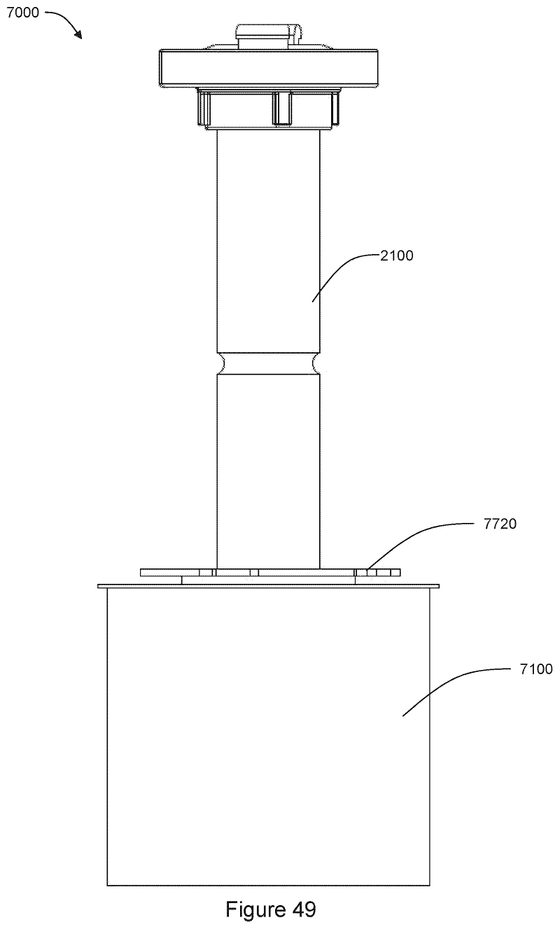

FIG. 50 shows a perspective view of a firefighting accessory connected to a mechanical lever style penetration assistance mechanism, the penetration assistance mechanism being mounted to an access facilitation conduit;

FIG. 51 shows a perspective view of the firefighting accessory, penetration assistance mechanism and access facilitation conduit of FIG. 50, with the firefighting accessory for penetrating through the access facilitation conduit;

FIG. 52 shows a side view of FIG. 51;

FIG. 53 shows a perspective view of the firefighting accessory, penetration assistance mechanism and access facilitation conduit of FIG. 50, with the handle of the lever opened to allow the penetration assistance mechanism to be removed from the firefighting accessory and access facilitation conduit;

FIG. 54 shows a side view of FIG. 50;

FIG. 55 shows a side view of FIG. 53;

FIG. 56 shows a cutaway schematic side view of a first embodiment of a hydraulic force multiplier mechanism for use with a hydraulic pump;

FIG. 57 shows a top perspective view of a hydraulic force multiplier mechanism attached to an access facilitation conduit and hydraulic pump;

FIG. 58 shows a top perspective view of the hydraulic force multiplier mechanism and hydraulic pump of FIG. 57 with a firefighting accessory extending into the access facilitation conduit and hydraulic force multiplier mechanism;

FIG. 59 shows a cutaway schematic side view of a second embodiment of a hydraulic force multiplier mechanism; and

FIG. 60 shows a cutaway schematic side view of an eight embodiment of an access facilitation conduit connected to a threaded mechanical force application mechanism.

### DESCRIPTION OF EMBODIMENTS

It should be noted in the following description that like or the same reference numerals in different embodiments denote the same or similar features.

An access facilitation conduit according to a first aspect of the invention is generally indicated by the numeral 1000.

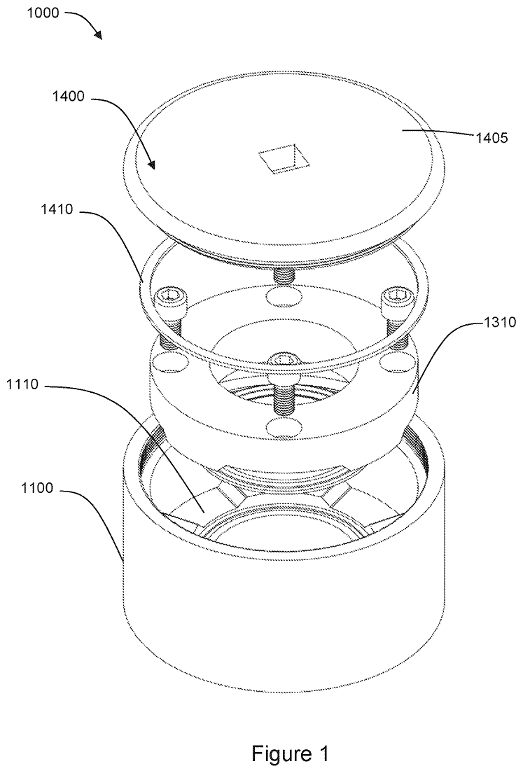

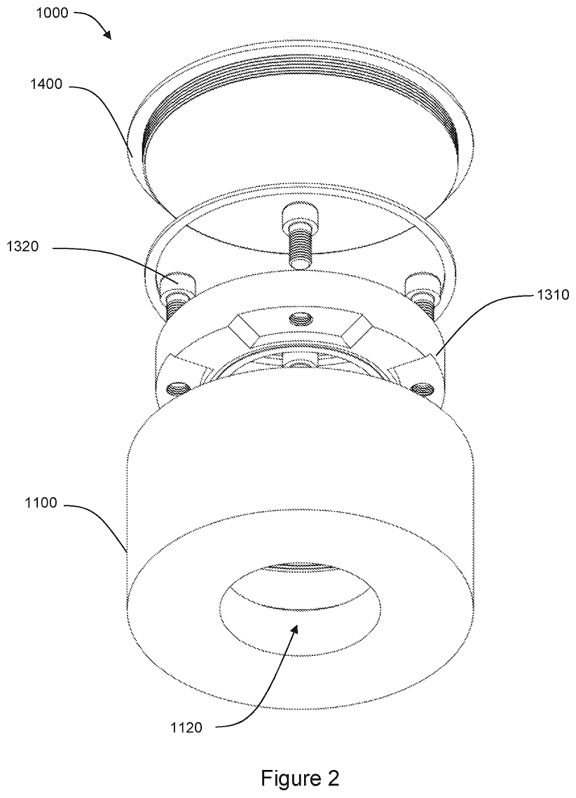

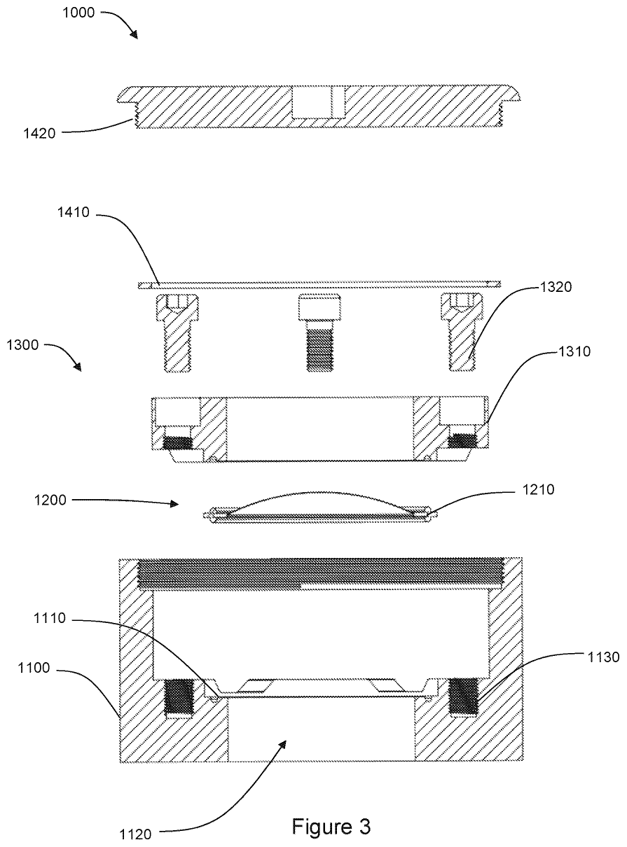

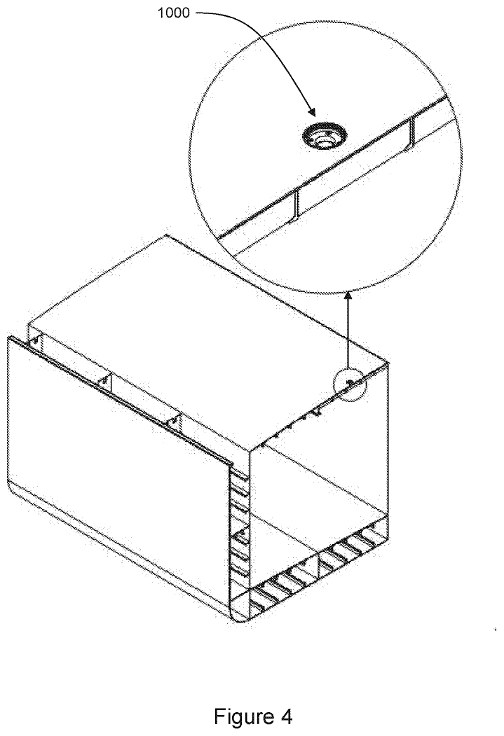

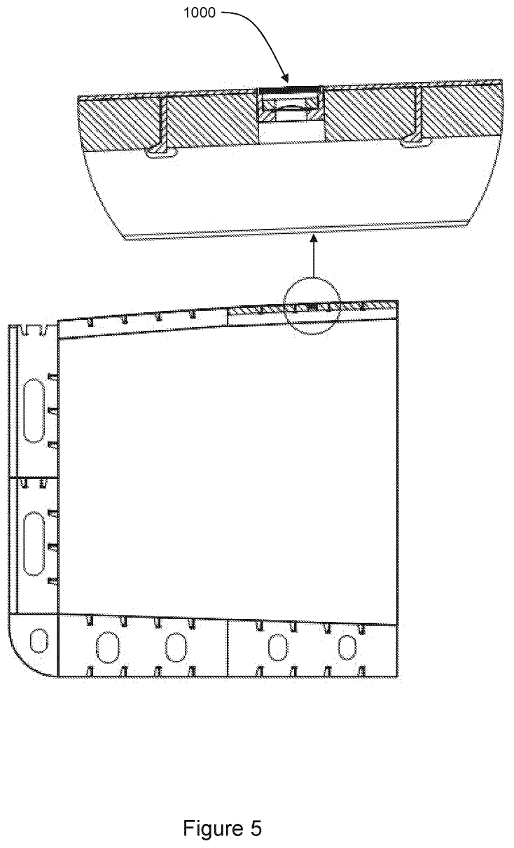

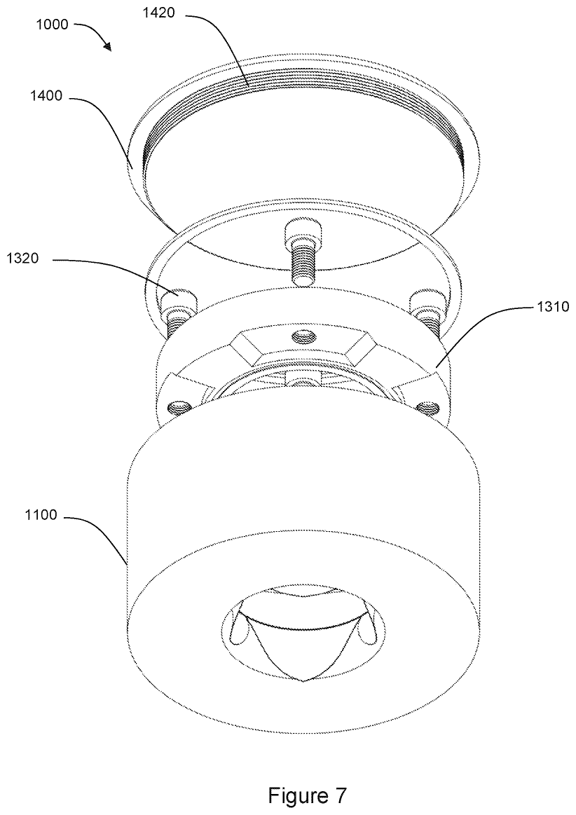

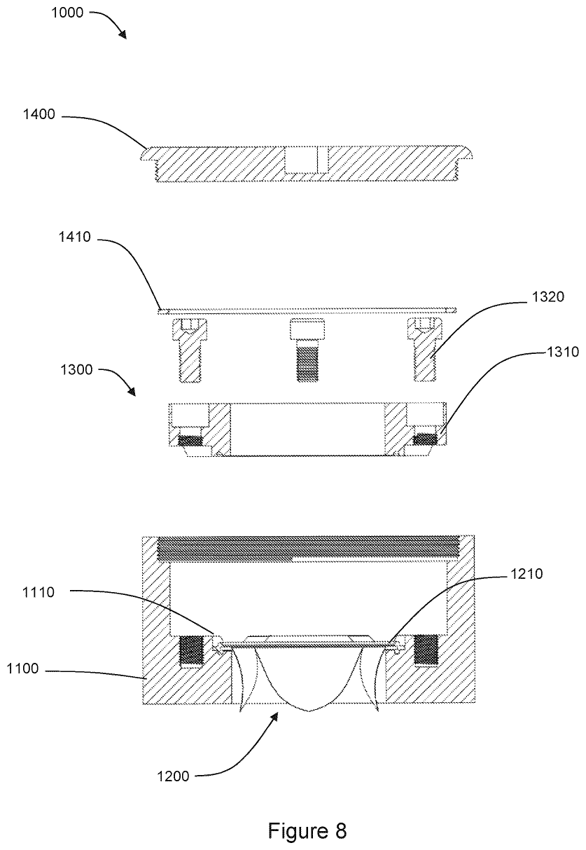

FIGS. 1 to 8 show an embodiment of the access facilitation conduit 1000 (or “deck box”) which includes a frame 1100 adapted to be mounted within an aperture of a barrier or deck or bulkhead of a compartment of a sea going vessel. An in-use view of the access facilitation conduit 1000 mounted within the aperture is shown in FIG. 4 and FIG. 5. The frame 1100 defines a passage 1120 therethrough. The frame 1100 also retains a rupturable membrane 1200 that is shown more clearly in FIG. 3. The rupturable membrane 1200 serves to restrict or occlude or at least partially occlude the passage and is also suitable for being ruptured by being punctured by a sharp object or bursting when a threshold pressure is reached.

The access facilitation conduit 1000 includes a clamping arrangement 1300 to clamp the rupturable membrane 1200 in a seated position within the frame 1100. The clamping arrangement includes an annular seat 1110 and an inner annular retaining formation 1310 that are held together by fasteners 1320. The rupturable membrane 1200 preferably includes a lip 1210 around its circumference. The lip 1210 of the rupturable membrane 1200 is clamped by the clamping arrangement 1300 such that the lip 1210 is seated on the annular seat 1110 that is integral or integrally formed within the frame 1100 and held down by the inner annular retaining formation 1310. The clamping arrangement 1300 retains the rupturable membrane 1200 in position within the frame 1100 on the annular seat 1110. A plurality of fasteners 1320 hold the inner annular retaining formation 1310 to the frame 1100. In the embodiment shown, the plurality of fasteners 1320 are in the form of bolts which pass through threaded apertures of the inner annular retaining formation 1310 and engage complementary threads in apertures 1130 in the frame 1100.

In an alternative embodiment (not shown) it is envisaged that an adhesive or any other securing or connection mechanism may be used to hold the inner annular retaining formation 1310 to the frame 1100. In an alternative embodiment utilising adhesive, the rupturable membrane 1200 may be permanently retained between the inner annular retaining formation 1310 and the annular seat 1110.

In an alternative embodiment (not shown), the rupturable membrane may be integrally formed with the frame by forming the lip into the frame during manufacturing of the frame.

The rupturable membrane 1200 is preferably a single-use membrane also known as a burst-disc or a rupture disc. The burst disc is designed to stay intact up until a threshold pressure is reached whereby it will then burst, revealing an open passage through the frame 1100. Alternatively, the burst disc may be punctured by a sharp object. Preferably the rupturable membrane 1200 is designed to rupture at very high pressures. For example, should the hull of a vessel be breached, the rupturable membrane 1200 should not rupture from pressures encountered within the compartment. Additionally, should a high-pressure blast, for example from an explosion, occur in the compartment, the rupturable membrane should be able to withstand this.

The inner annular retaining formation 1310 and the annular seat 1110 are both castellated to help with aligning the parts and seating the rupturable membrane 1200 during assembly and replacement of the rupturable membrane 1200. Preferably the castellations are configured so that the annular retaining formation 1310 and the annular seat 1110 can only be assembled in one way. An annular disc or annular member 1410 is provided to assist with keeping the inner annular retaining formation 1310 in position.

As shown in FIG. 4 and FIG. 5, the access facilitation conduit 1000 may be either removably attached or permanently attached to the deck of a marine vessel. If a permanently retained rupturable membrane 1200 is used within an access facilitation conduit, then the access facilitation conduit 1000 itself will need to be removably attached to the deck of a marine vessel, otherwise the rupturable membrane 1200 will not be able to be replaced. A permanently attached access facilitation conduit 1000 will be installed in the deck of a marine vessel where the rupturable membrane 1200 is removable from the frame 1100. An access facilitation conduit 1000 may be permanently attached by welding, or may be removably attached by providing suitable flanges with fastening holes for receiving fasteners such as bolts.

Also shown in FIGS. 1 to 8 is a cover arrangement which includes a closure member 1405. The closure member 1405 is screwed onto the frame 1100 via complementary threads 1420 so that it is removable.

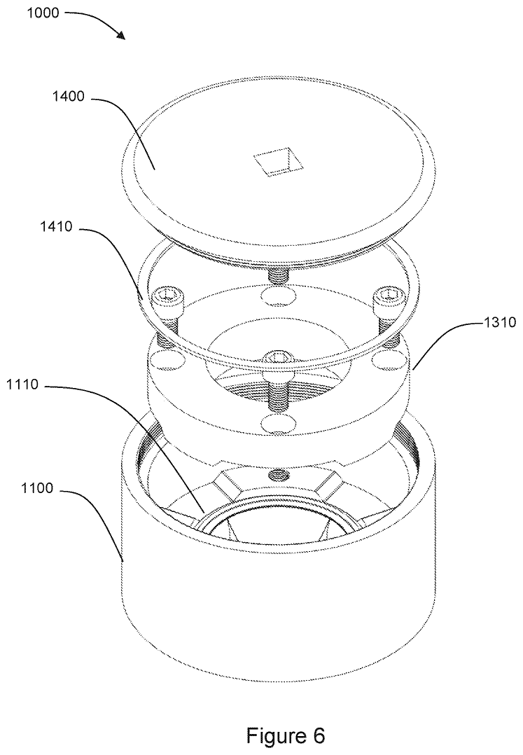

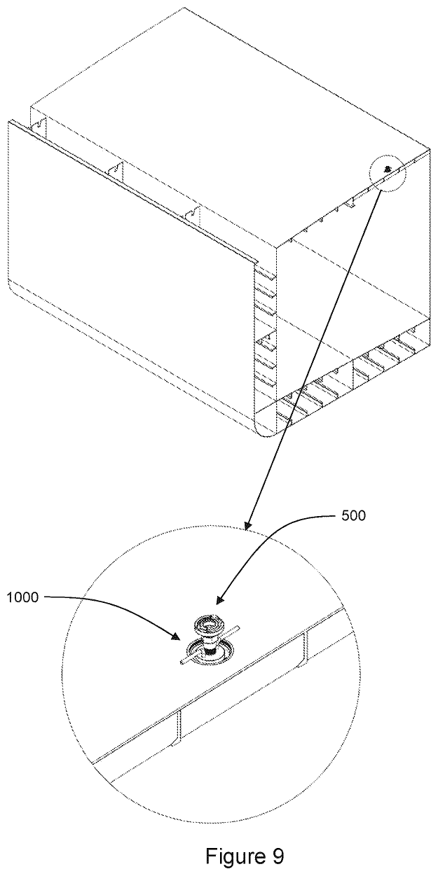

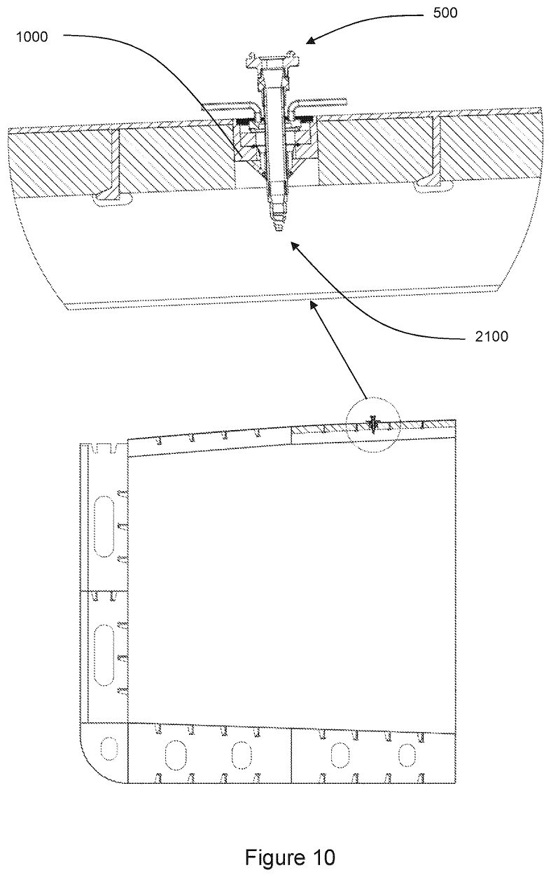

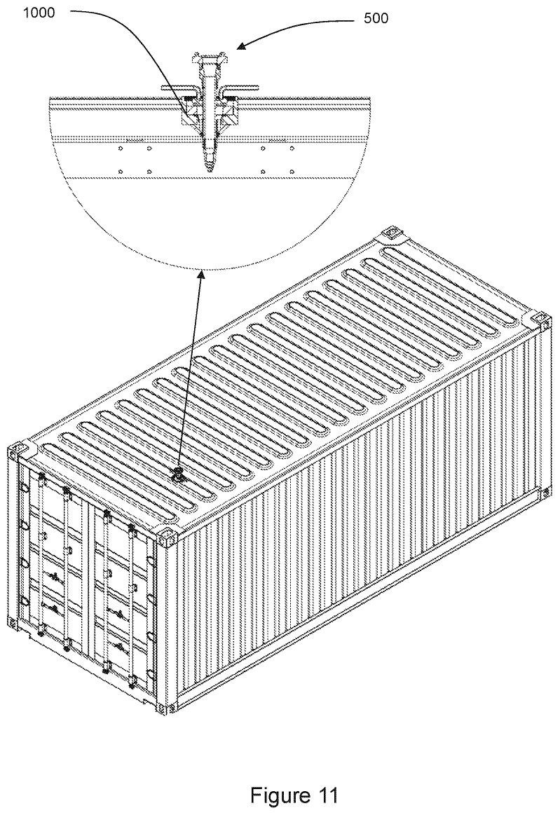

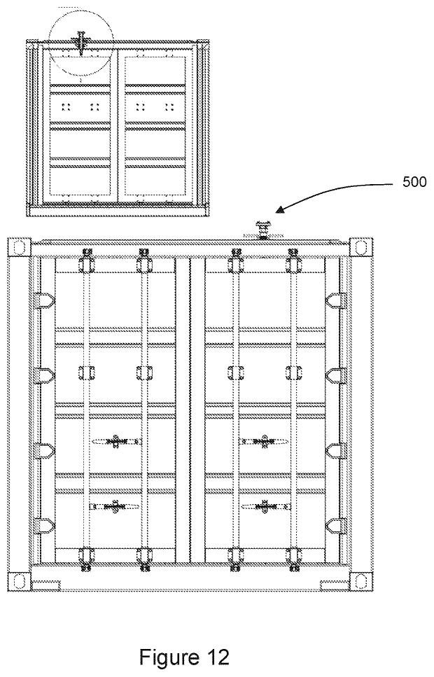

FIGS. 6 to 12 show an embodiment where the membrane 1200 has been ruptured. FIGS. 9 to 12 in particular, show a firefighting accessory 500 including a nozzle 2100 that has been used to rupture the membrane 1200 to provide access to a compartment on an opposed side of the location of the firefighter. The firefighting accessory 500 may be similar to the firefighting accessory shown in PCT publication WO2022/115896, which is incorporated by reference. In use, the nozzle of the firefighting accessory is moved through the occluded passage 1120, rupturing the membrane 1200 so that the nozzle extends into, reaches or accesses the interior of the compartment. The firefighting accessory is preferably sealingly engaged with the frame 1100. Specifically, the inner annular retaining formation 1310 abuts against the body of the firefighting accessory 500 to create a seal. Once a seal is achieved, the firefighting accessory 500 is connected to a hose to flow firefighting agent through the accessory and into the compartment to put out a fire therein.

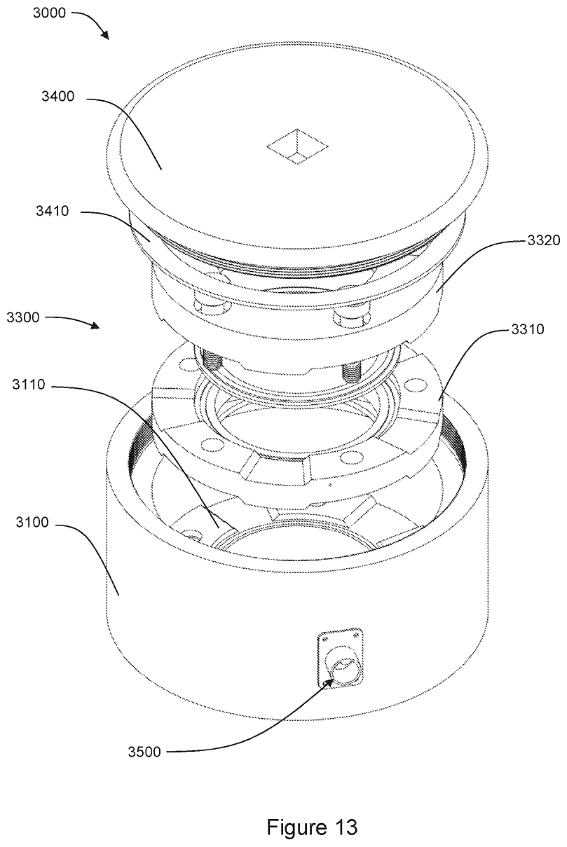

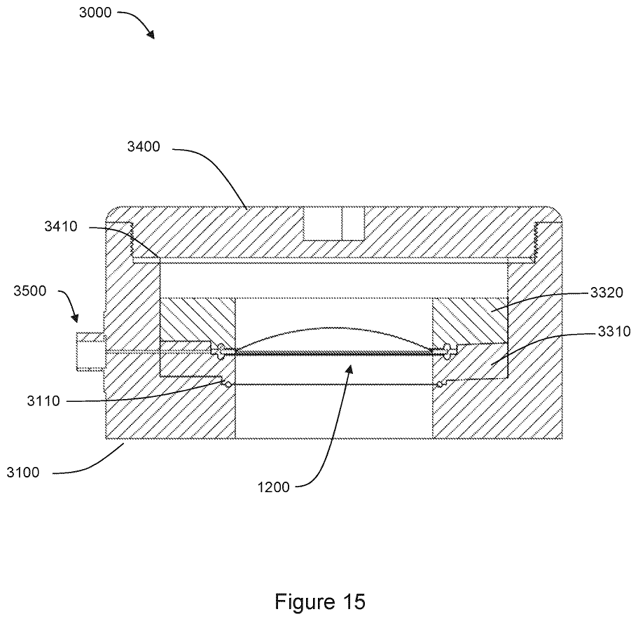

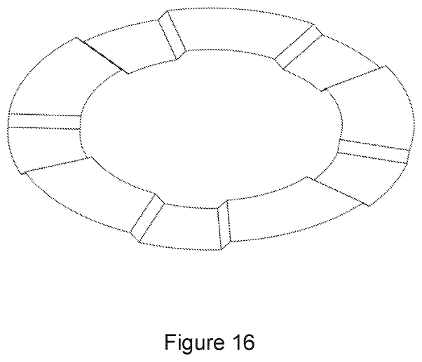

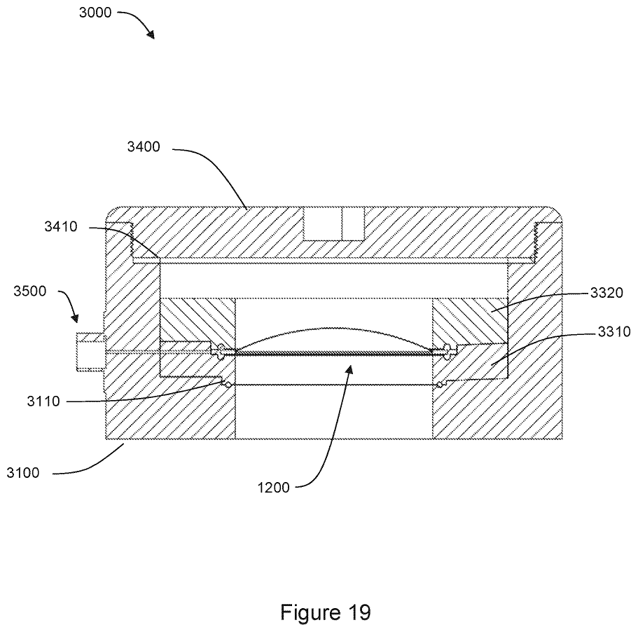

FIGS. 13 to 19 show an access facilitation conduit 3000 according to a second embodiment. The access facilitation conduit 3000 is adapted to be mounted within an aperture of a barrier or deck of a sea going vessel to provide access to a compartment. The access facilitation conduit 3000 is similar to the conduit 1000 but has extra parts.

The like parts of the access facilitation conduit 3000 include: a cover arrangement 3405 including a closure member 3405; a frame 3100; a clamping arrangement 3300; an annular seat 3110 that is integrally formed with the frame 3100; and the rupturable membrane 1200.

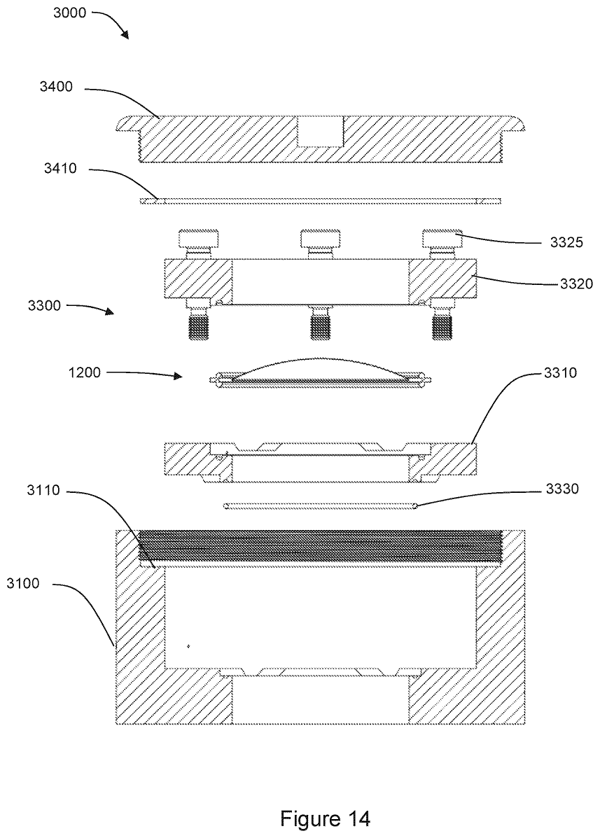

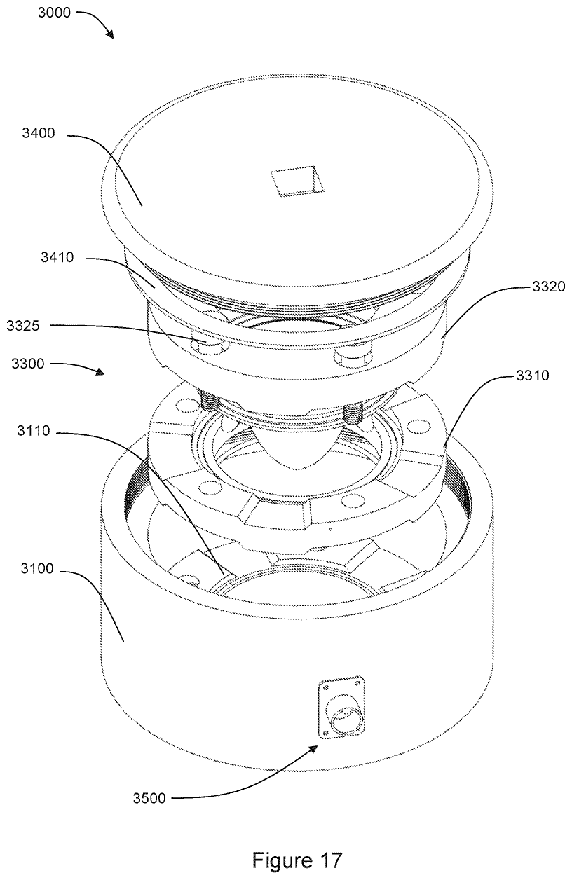

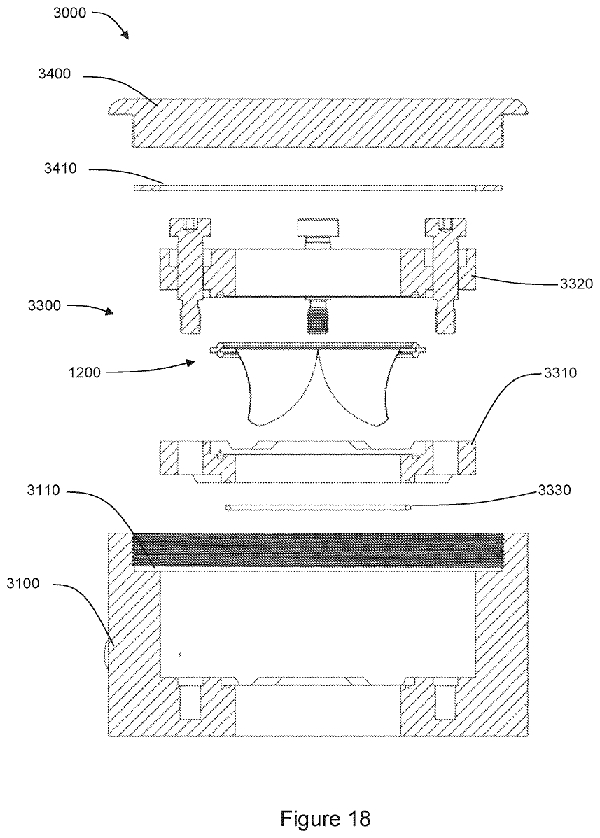

The like parts listed above fit together in a very similar manner to the parts used to assemble the access facilitation conduit 1000. However, one notable difference is the clamping arrangement 3300. The clamping arrangement 3300 comprises a first inner annular retaining formation 3310 and a second inner annular retaining formation 3320. As shown most clearly in FIG. 14, the first inner annular retaining formation 3310 and the second inner annular retaining formation 3320 clamp the rupturable membrane 1200 by sandwiching the lip 1210 of the membrane 1200 between the first and second inner annular retaining formations 3310, 3320. These two inner annular retaining formations are held together by fasteners 3325 (shown in FIG. 14) which also threadingly engage the annular seat 3110. There is also a seal in the form of an O-ring 3330 between the annular seat 3110 and the first inner annular retaining formation 3310 to prevent harmful gasses passing out of the compartment in the event of a fire. FIGS. 17 and 18 show the access facilitation conduit 3000 when the rupturable membrane 1200 has been ruptured.

The clamping arrangement 3300 with extra inner annular retaining formations 3310, 3320 allow the rupturable membrane 1200 to include a segment of electrically conductive material integrated into the membrane so that if electrical continuity is broken, an electrical signal is passed to the control centre of the sea going vessel to alert the user that there is an issue in a particular compartment, such as a fire. The electrically conductive material may be connected to a wiring harness (not shown) via a passage 3500. The membrane 1200 or frame 1100 may have a temperature sensor and may be integrated for such alerts.

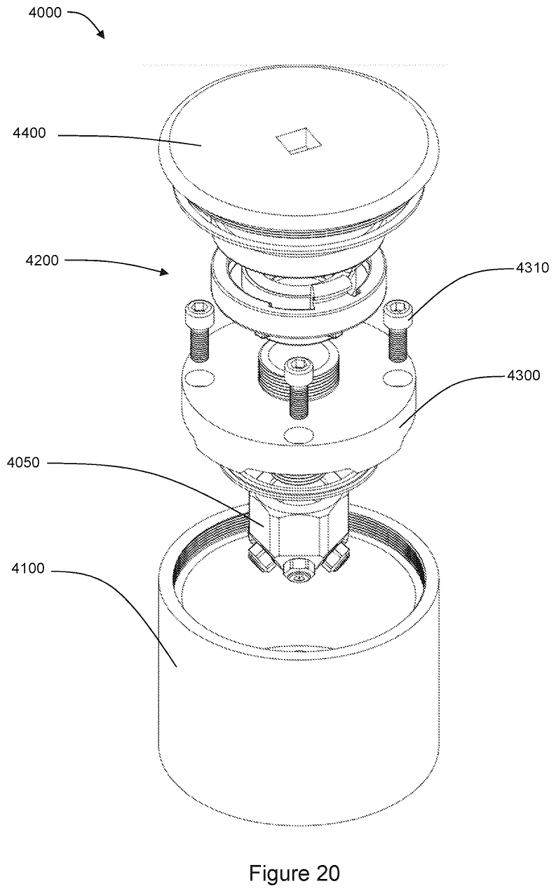

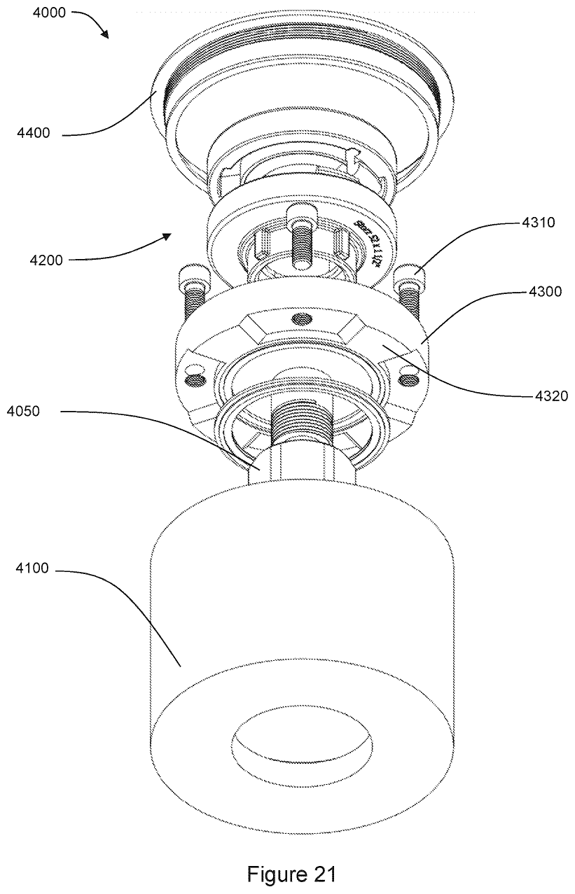

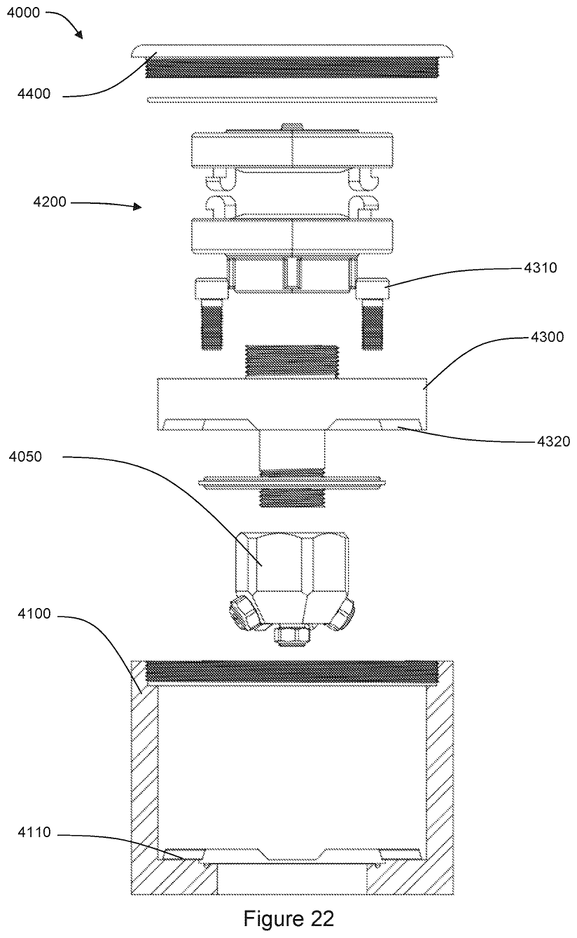

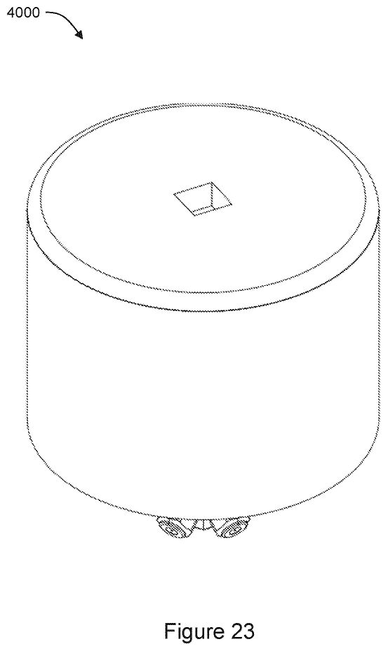

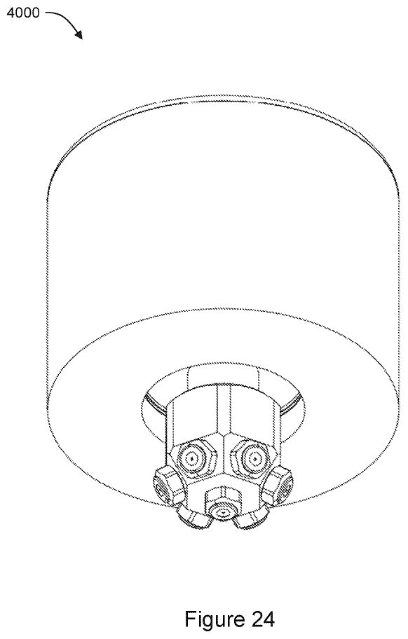

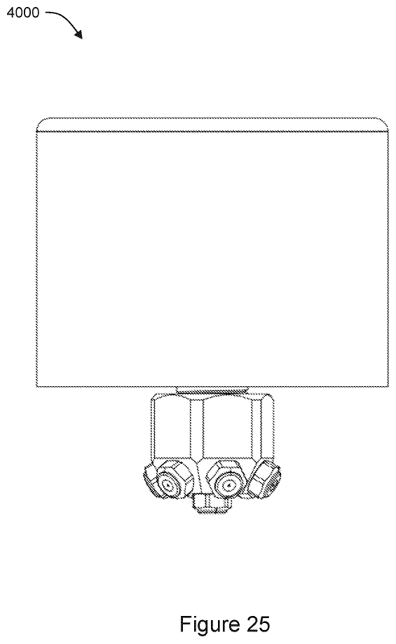

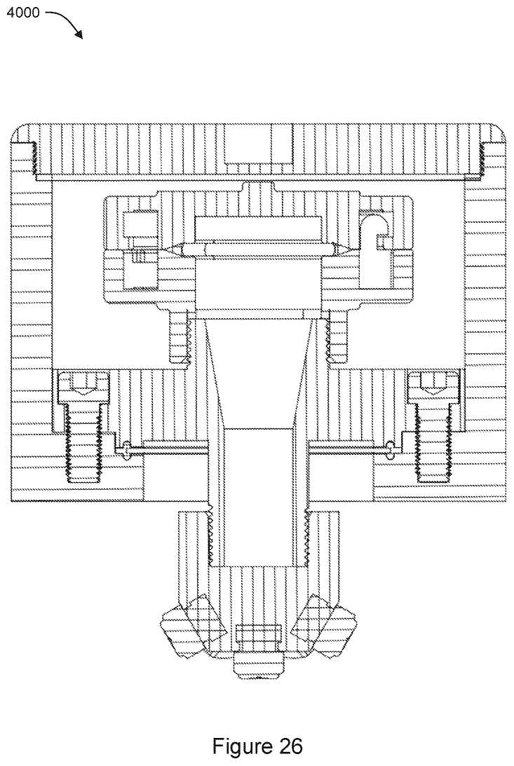

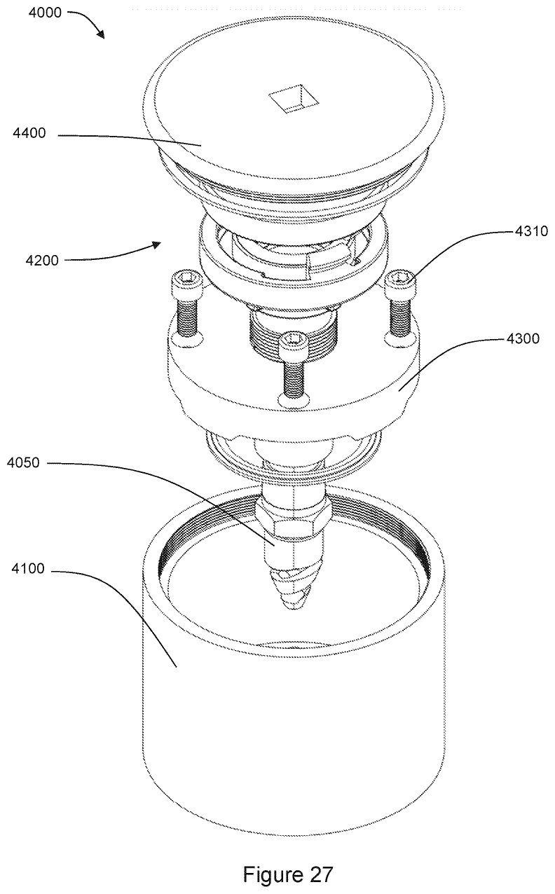

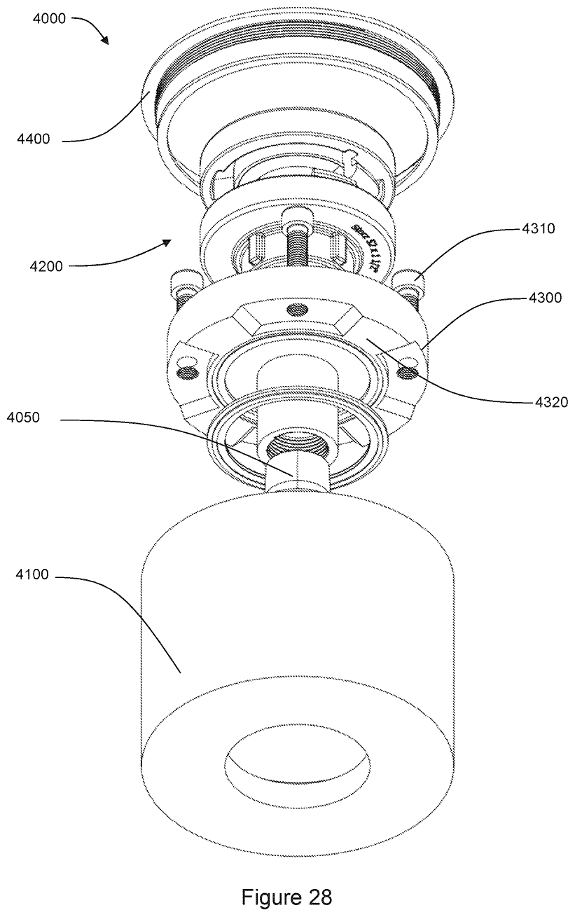

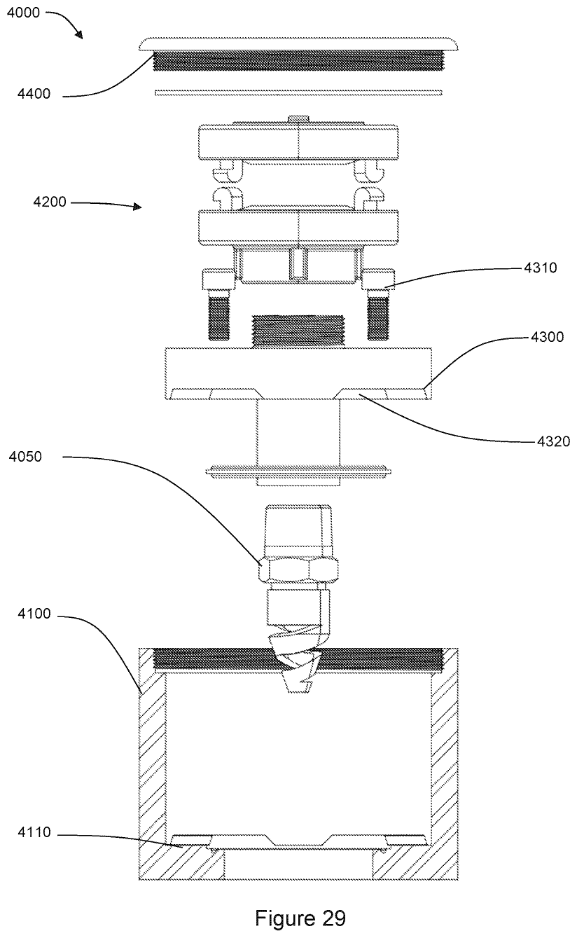

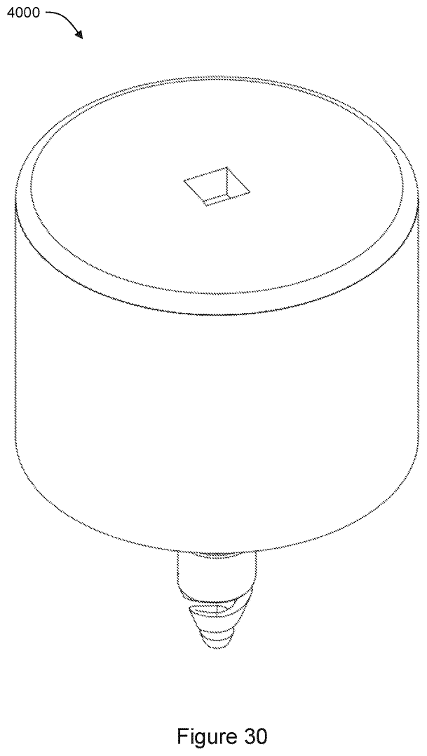

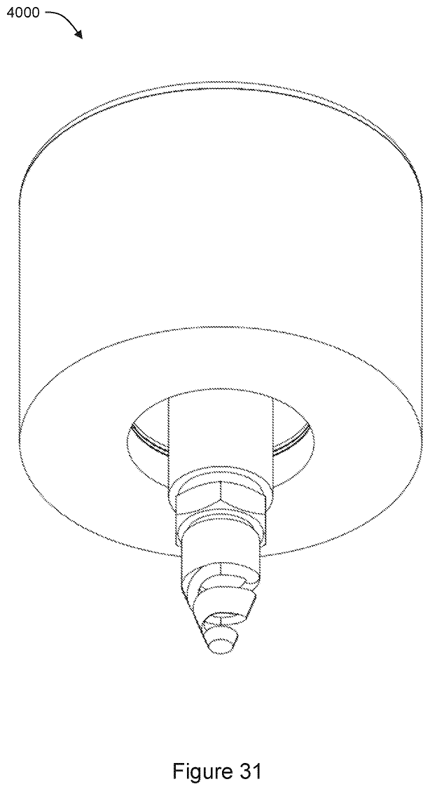

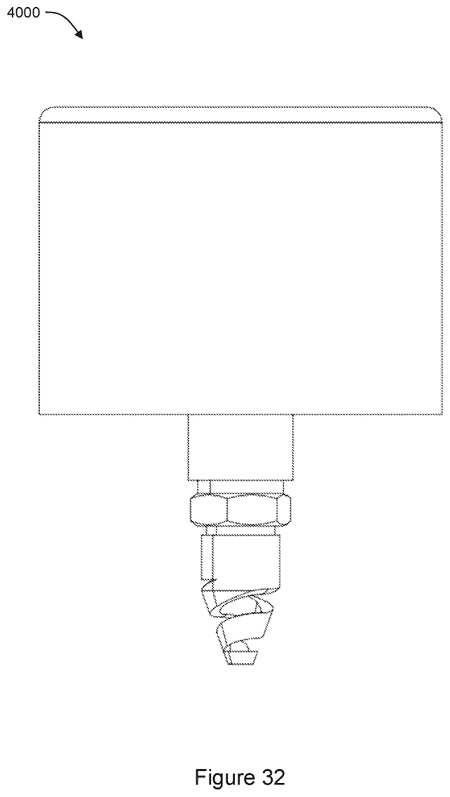

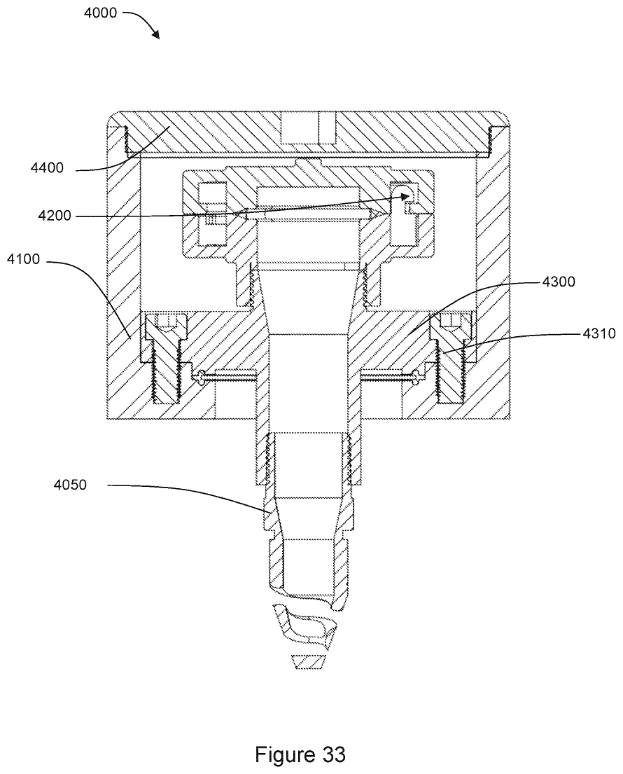

FIGS. 20 to 33 show an access facilitation conduit 4000 according to a third embodiment. The access facilitation conduit 4000 includes a frame 4100 to allow the conduit 4000 to be mounted within an aperture of a barrier or deck. The frame 4100 defines a passage to allow the flow of firefighting agent therethrough.

The access facilitation conduit 4000 further includes a nozzle 4050 that is attached to the frame 4100. The nozzle 4050 is in fluid communication with the passage to allow the flow of firefighting agent into the compartment beyond the barrier or deck.

The access facilitation conduit 4000 also includes a fire extinguishing agent connector arrangement 4200 and an inner annular retaining formation 4300 to hold the agent connector arrangement within the frame 4100. The agent connector arrangement 4200 is threadedly connected to the inner annular retaining formation 4300 by complementary threaded formations, which in turn is fastened to the frame 4100 by a plurality of fasteners 4310. In the embodiment shown, the fasteners are bolts. However, it is envisaged that other suitable fasteners may be used. The agent connector arrangement 4200 is shown to have a standard bayonet style or quick connect formation to allow a source of fire extinguishing agent (such as a fire hose or fire extinguisher) to be rapidly connected to the access facilitation conduit 4000 and thereby allow the flow of fire extinguishing agent through the passage. A cover 4400 that is retainable by the frame 4100 is also provided. The cover 4400 preferably seals against the frame. The cover 4400 is removable to allow access to the connector arrangement 4200. The frame 4100 has an integral annular seat 4110 to hold the inner annular retaining formation 4300. The inner annular retaining formation 4300 has a castellated portion 4320 which abuts against a complementary castellated portion of the integral annular seat 4110.

It is envisaged that the access facilitation conduit 4000 may be either permanently attached or removable attached to the deck of a marine vessel by welding, riveting or any other suitable means. It is also envisaged that the nozzle connected to the frame may be a female or male style of nozzle, depending on the required application.

It is also envisaged that whilst the access facilitation conduit 4000 as shown in the figures does not have the rupturable membrane 1200, other embodiments may include the rupturable membrane 1200 to at least partially occlude, and preferably seal, the passage.

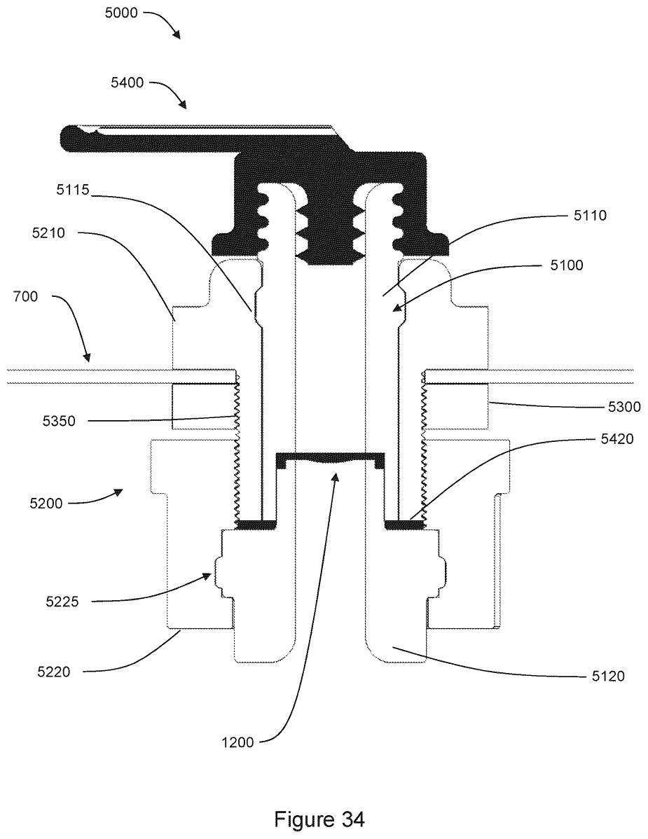

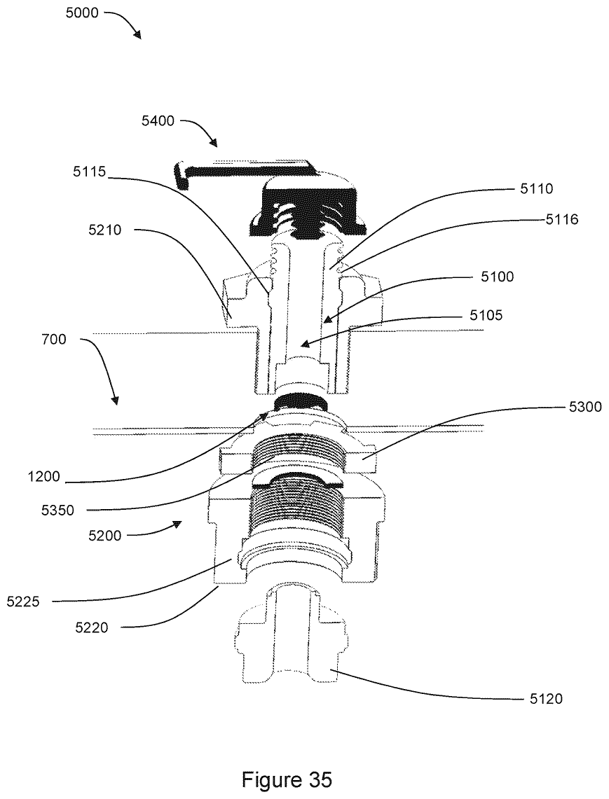

FIGS. 34 and 35 show an access facilitation conduit 5000 installed in a barrier 700 according to a fourth embodiment. The conduit 5000 is intended to provide access to a compartment having an aperture in its barrier 700. Such a compartment might be, for example, an electrical switching box containing busbars or a switchboard where a fire or other accident may cause electrical arcing from an electrical component within the compartment to the surround of the compartment.

The access facilitation conduit 5000 includes an electrically insulative body member 5100 which defines a passage to allow fire extinguishing agent to flow therethrough. The body member 5100 includes connecting formations 5116 at a distal end, the connecting formations 5102 being configured for connecting to a source of fire extinguishing agent, such as a fire hose, or the like. In the embodiment shown, the connecting formations are threaded formations, however in alternative embodiments (not shown) the connecting formations can include threaded formations, a bayonet formation, or any suitable connecting formation.

The body member 5100 may be made from ceramic or other suitable electrically non-conductive and heat resistant material. There is also a retaining arrangement 5200 which comprises multiple pieces to attach the electrically insulative body member 5100 and securely mount the body member 5100 within the aperture of the barrier 700 as will be described below.

The electrically insulative body member 5100 includes an outer insulative passage member or piece 5110 and an inner insulative passage member or piece 5120. Together, the inner and outer insulative pieces 5110 and 5120 hold the rupturable membrane 1200 in position between them to at least partially occlude the passage. The outer insulative piece 5110 includes threaded formations 5116 to connect to a source of firefighting agent. There is also a seal 5130 in the form of an O-ring provided between the inner insulative piece and the outer insulative piece.

The inner insulative piece and outer insulative piece 5110 and 5120 are held together by the retaining arrangement 5200. The retaining arrangement 5200 includes an outer retaining member 5210 and an inner retaining member 5220. The outer retaining member 5210 substantially circumscribes the cylindrical outer insulative piece 5510 to engage with and retain the position of the outer insulative piece via complementary engaging formations 5115. The outer retaining member 5210 is connected by complementary threaded fastening formations to the inner retaining member 5220. The inner insulative piece 5120 is press fitted into the inner retaining member 5220 at complementary engaging formations 5225. Complementary engaging formations 5225 shown include a convexly curved ring extending around inner insulative piece that engages with a concave channel in the inner retaining member 5220.

When the inner retaining member 5220 is tightened along the thread of the outer retaining member 5210, the inner insulative piece 5120 and the outer insulative piece 5110 are pushed toward each other, thereby clamping the rupturable membrane 1200.

In addition a body retaining member 5300 is provided for retaining the electrically insulative body member 5100 in position in the aperture of the compartment surround or barrier 700. The body retaining member 5300 preferably engages with the outer retaining member 5210 at complementary threaded engaging formations 5350 to clamp the barrier 700 or a wall of the compartment surround between the body retaining member 5300 and the outer retaining member 5210 to thereby fix and locate the access facilitation conduit 5000 in position.

It is further envisaged that in an alternative embodiment (not shown), the body member 5100 can include a flange extending radially at the distal end, proximately of the connecting formations 5116. The flange may serve to further shield a firefighter from the outer retaining member 5210 and the barrier 700.

In use, the body member 5100 is connected to a source of fire extinguishing agent to guide the agent through the passage. A firefighter can freely handle or contact the body member 5100 without fear of being electrocuted as the body member is electrically insulated from any wayward discharge in the electrical compartment. In this embodiment, it is envisaged that the rupturable membrane 1200 will be rupturable at a low-pressure, so pressure from the agent source ruptures the rupturable membrane 1200 to allow the agent to flow through into the compartment.

In an alternative embodiment (not shown), it is envisaged that the inner insulative piece 5120 may include a nozzle to disperse or atomise the firefighting agent within the compartment. In an alternative embodiment (not shown), the inner insulative piece 5120 can include connective formations for connecting to a nozzle that is suitable for the interior of the compartment. When not in use, a cover 5400 is provided to cover and protect the rupturable membrane 1200. The cover 5400 is preferably composed of an insulative plastic with complementary threaded formations for turning onto the threaded formations 5116 of the outer insulative piece 5110.

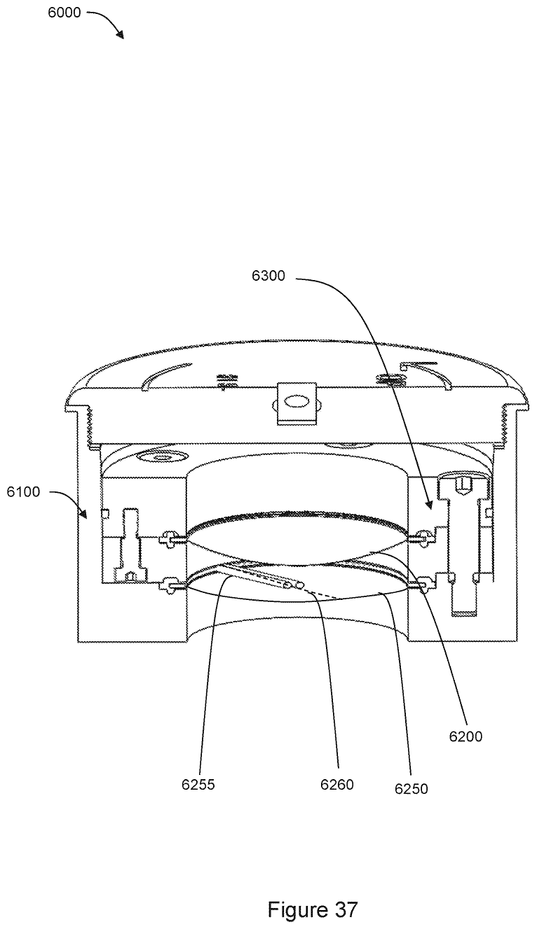

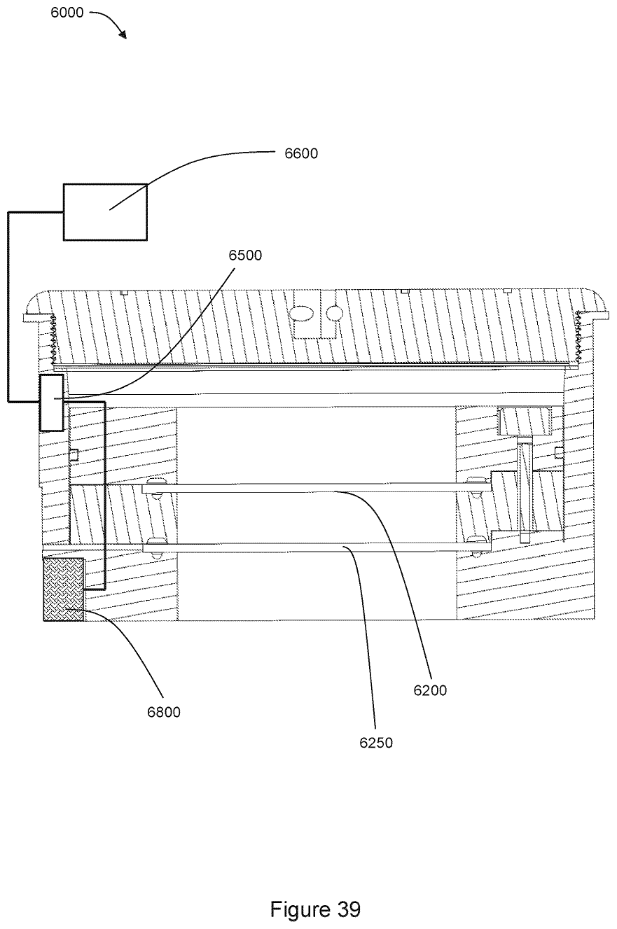

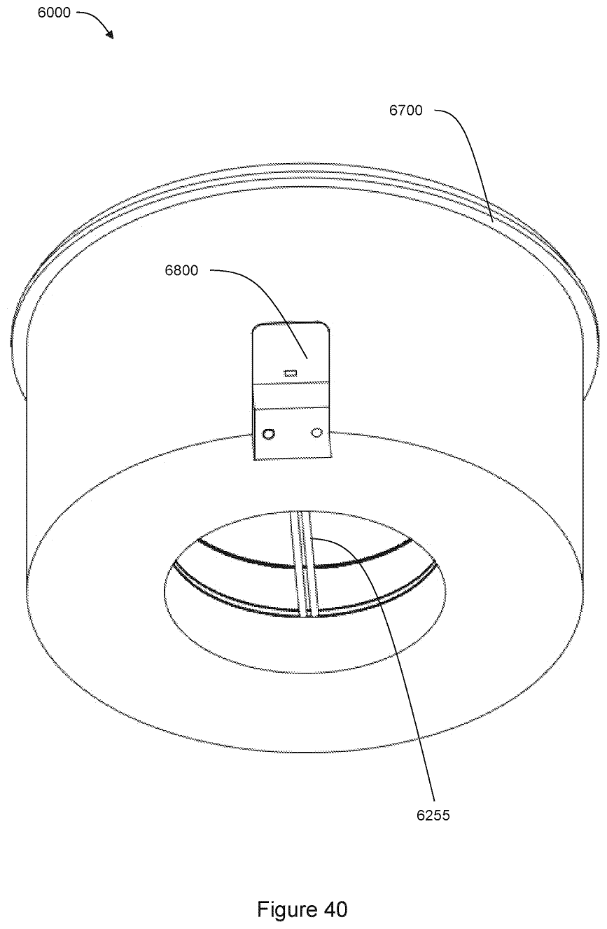

FIGS. 37-40 show a further embodiment of an access facilitation conduit 6000 that includes a frame 6100, a primary rupturable membrane 6200 and a clamping arrangement 6300 that are similar to the access facilitation conduits described above.

However, access facilitation conduit 6000 includes a secondary rupturable membrane 6250 in addition to a primary rupturable membrane 6200. The primary rupturable membrane 6200 is similar to the rupturable membranes 1200 described above in that it is adapted for high pressures and to prevent leakage through the access facilitation conduit 6000 in the event of water ingress into the compartment.

The secondary rupturable membrane 6250 is for use as a detector for detecting a high-pressure event such as an explosion in the compartment. The secondary rupturable membrane 6250 is located on the compartment side of the primary rupturable membrane 6200. The secondary rupturable membrane preferably includes a bimetallic strip 6255 that is located to either side of a line of engineered weakness 6260 such as a perforated line in the secondary rupturable membrane 6250. When the secondary rupturable membrane 6250 is ruptured, electrical connection between the bimetallic strip on either side of the perforated line is lost. Such rupturable membranes are known in the art, and can, for example be found for sale by Fike Corporation as “rupture disc burst indicators” at https://www.fike.co.uk/en_gb/products/rupture-disc-burst-indicator/. The secondary rupturable membrane 6250 can also be used to give an indication that the primary rupturable membrane 6200 has been ruptured.

The bimetallic strip 6255 may be electrically connected by wiring through the frame and/or the clamping arrangement in a watertight manner, so that it can be electrically connected to a transmitter 6600 and/or transceiver and/or electrical circuitry outside of the compartment.

The access facilitation conduit 6000 may also include a power source such as a battery (not shown) for powering the sensors and/or transmitter and/or circuitry. Data from the sensors can be transmitted to a ship wide monitoring and/or control system.

It is further envisaged that that the access facilitation conduit will include a plurality of sensors 6800 (in addition to the bimetallic strip 6255) that are located on the compartment side of the access facilitation conduit, and which can be electrically connected to the transceiver and/or electrical circuitry outside of the compartment, and in a watertight manner. It is envisaged that such sensors could include sensors for sensing at least one or more selected from:
a. temperature;
b. humidity;
c. pressure;
d. pH;
e. light; and
f. any other characteristic.

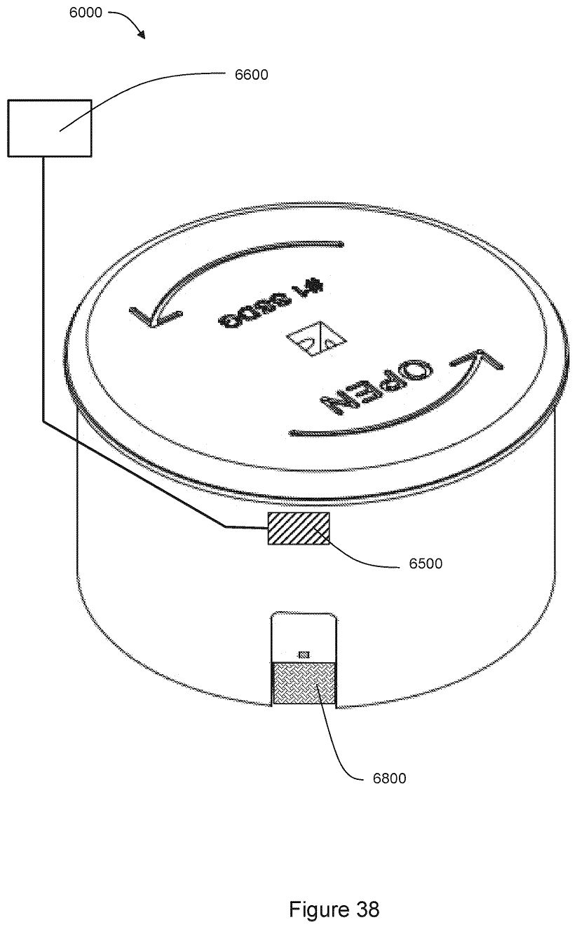

As shown in FIGS. 38-40, the access facilitation conduit can include an electrical terminal 6500 that can be conveniently connected to electrical circuitry such as a vessels monitoring system. The electrical terminal 6500 is preferably located to be accessible from outside of the compartment. The electrical terminal 6500 can be connected to a transmitter 6600 and/or transceiver. The transmitter 6600 is configured for transmitting data received from the one or more sensors to a ship wide management system. Such transmission could be wireless or wired.

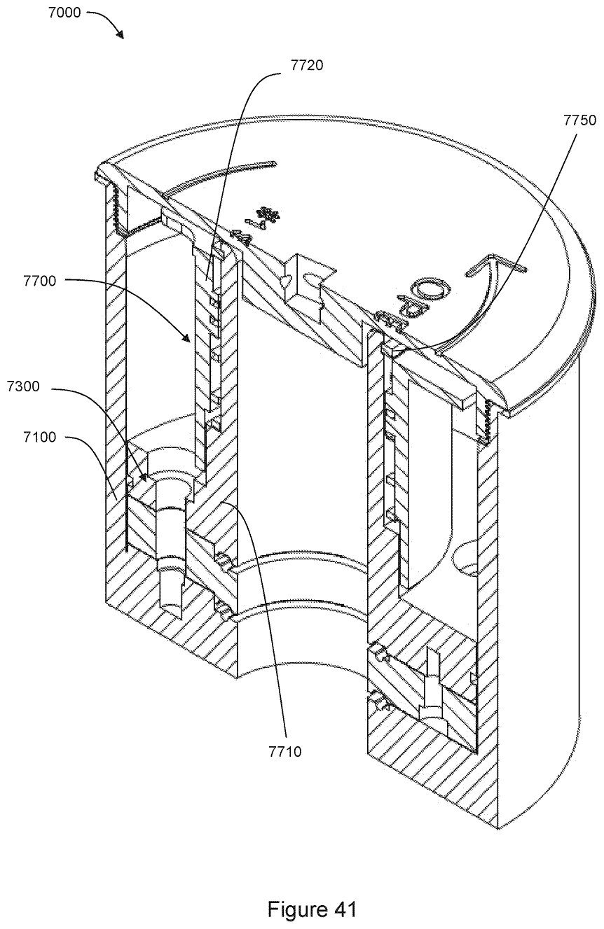

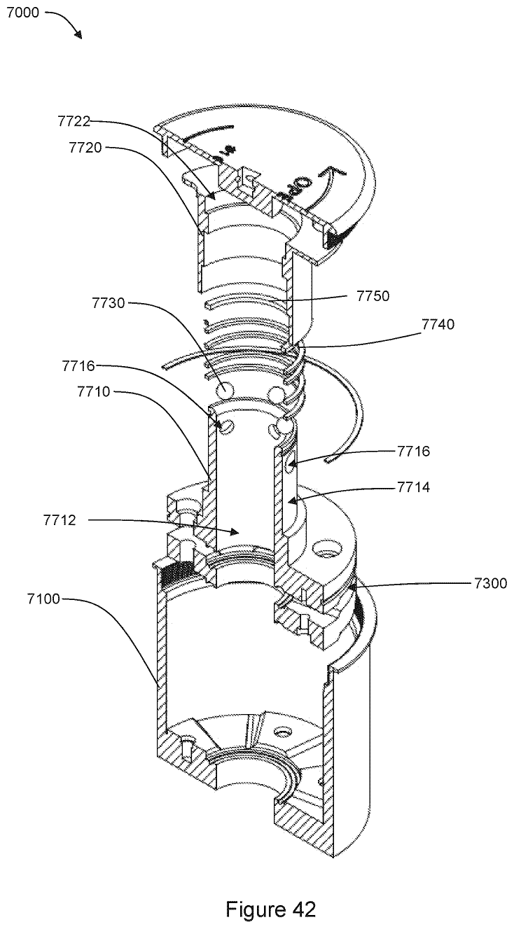

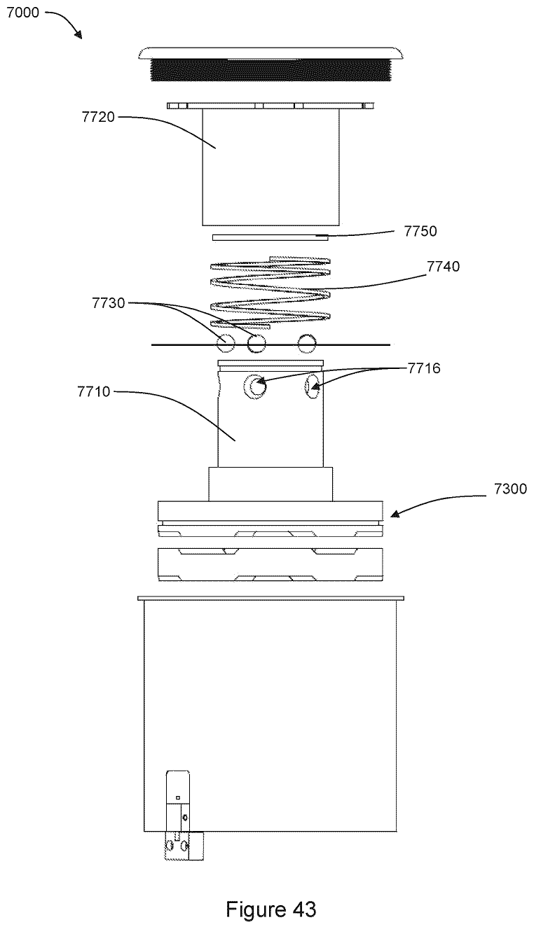

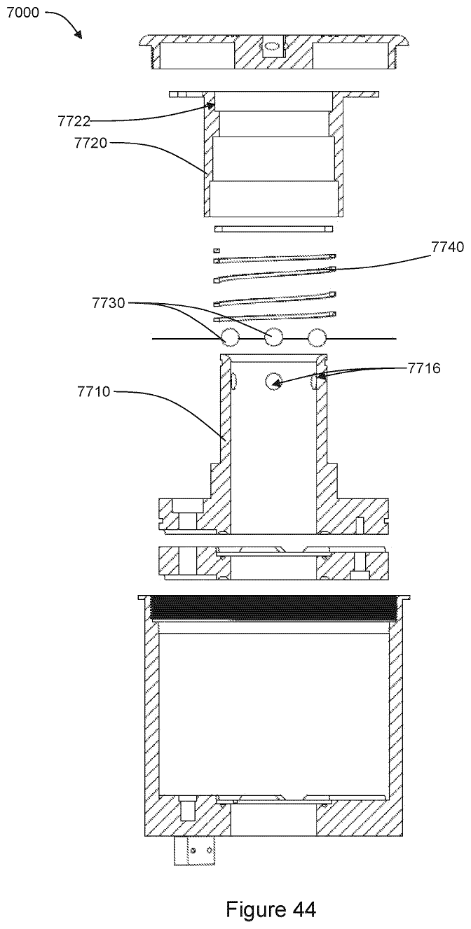

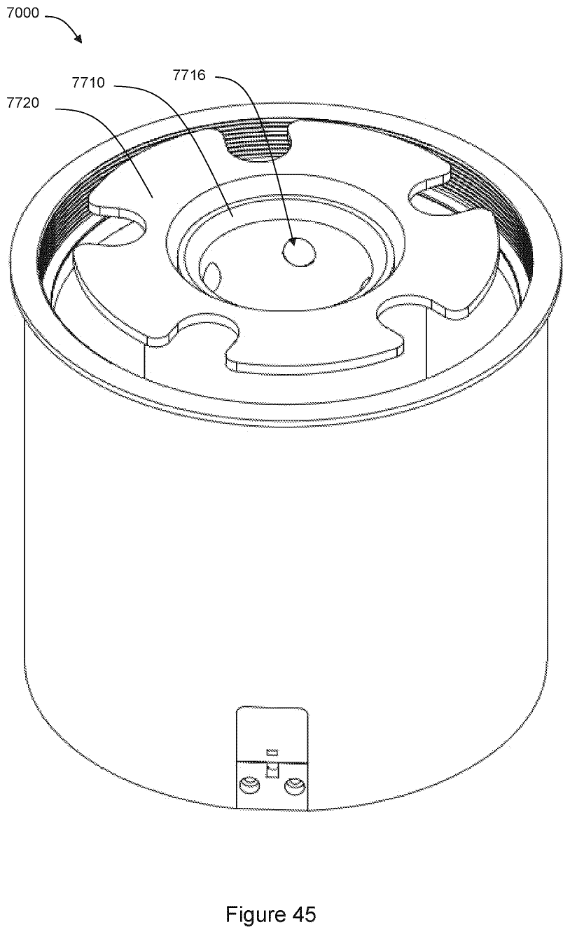

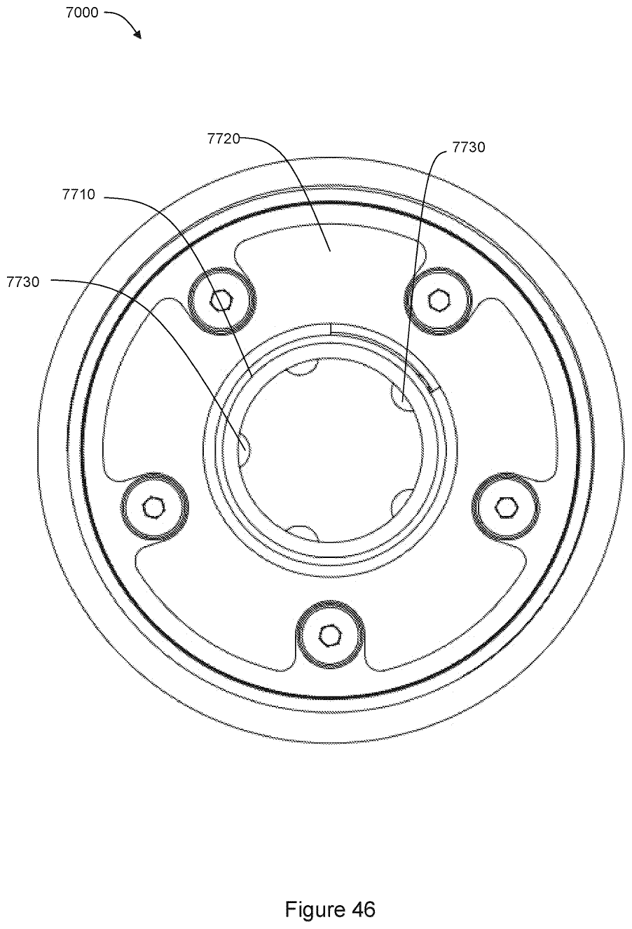

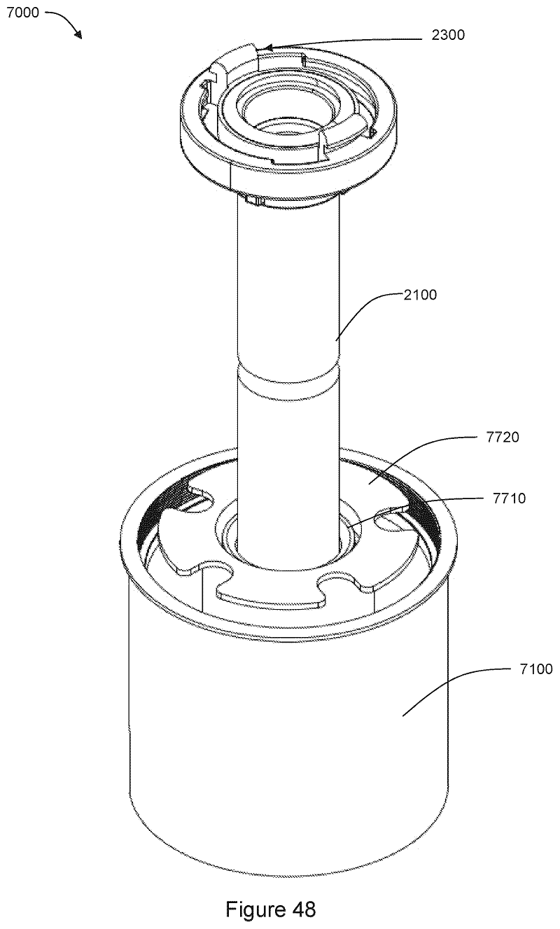

FIGS. 41-48 show a further embodiment of an access facilitation conduit 7000 in which the access facilitation conduit 7000 includes a quick connector mechanism 7700 that allows a firefighting accessory 2000 to be inserted at least partially through the access facilitation conduit 7000 and which allows the firefighting accessory 2000 to be locked into place instantaneously and removably. Similarly to the other access facilitation conduits described above, this access facilitation conduit 7000 includes a frame 7100, a primary rupturable membrane 7200, a secondary rupturable membrane 7250 and a clamping arrangement 7300. However, the access facilitation conduit 7000 further includes a quick connector mechanism 7700 adapted for allowing convenient quick connection of the firefighting accessory. Quick connector mechanism 7700 includes an inner annular member 7710, hollow outer sleeve 7720, spherical members in the form of ball bearings 7730, spring 7740 and retaining circlip 7750. Inner annular member 7710 is receivable within the hollow outer sleeve 7720.

Inner annular member 7710 defines an inner face 7712 and an outer face 7714 and a plurality of tapered apertures 7716 configured to seat the ball bearing 7730 within each tapered aperture 7716. The tapered apertures 7716 extend from a larger size aperture on the outer face to a smaller size aperture on the inner face.

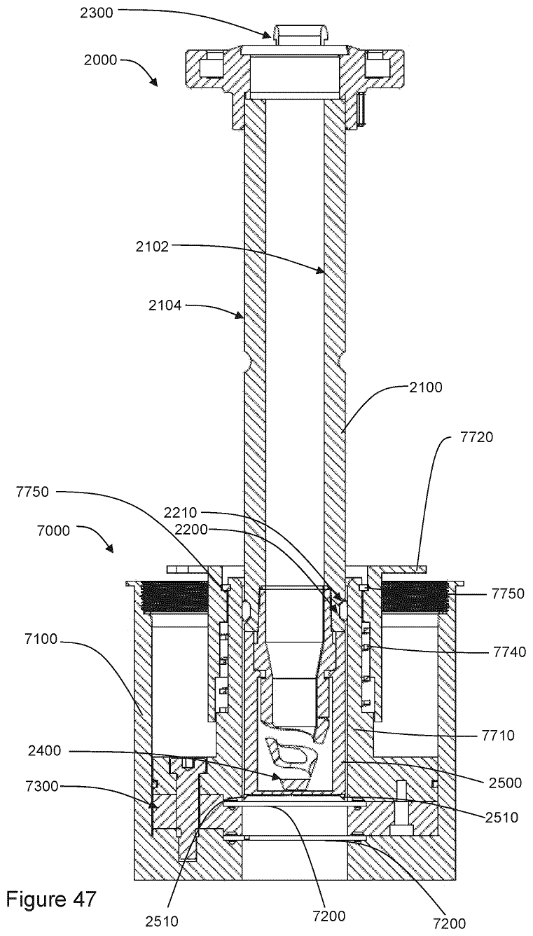

The ball bearings 7730 are each movable between a seated position (shown in FIG. 47) in which it is seated in the tapered aperture 7716 to extend inwardly of the inner face of the inner annular member, and an unseated position in which the ball bearing does not extend inwardly of the inner face 7712 of the inner annular member 7710.

The outer sleeve 7720 is movable between a locked condition (shown in FIG. 47) in which it locks the ball bearing 7730 in its seated position and an unlocked condition in which the ball bearing 7730 is able to move to an unseated position. The outer sleeve 7720 is spring biased by the spring 7740 to its locked condition. The outer sleeve 7720 can preferably be moved manually from its locked condition to its unlocked condition by pushing the outer sleeve against the spring bias. When the outer sleeve 7720 is moved to its unlocked condition, for example by being pushed downwardly in FIG. 47, ball bearing 7730 will be able to move from their seated position into their unseated position by moving into the undercut 7722 in outer sleeve 7720. Retaining circlip 7750 serves to retain the ball bearings 7730 from falling out when the ball bearings moved to their unseated position.

The quick connector mechanism 7700 is adapted to capture a firefighting accessory that is inserted into the inner annular member 7710 by causing ball bearings to be inserted into a recess 2210 on the firefighting accessory 2000, to thereby prevent retraction of the firefighting accessory once it has been inserted into the quick connector mechanism.

In use, in order to insert the firefighting accessory 2000 into the quick connection mechanism 7700, the outer sleeve 7720 must be pushed in. When the outer sleeve 7720 is pushed into its unlocked condition, this allows ball bearings 7730 the space to move from their seated position to their unseated position. When the ball bearings 7730 are in their unseated position, the sleeve is sufficient space for the firefighting accessory 2000 to be received within the hollow inner annular member 7710.

Firefighting accessory 2000 includes an annular body member 2100 in the form of a hollow tube for guiding the passage of firefighting agent from a source of firefighting agent. The annular body member 2100 defines an inner surface 2102 and an outer surface 2104. The firefighting accessory includes a quick coupling connection formation 2200 in the form of a recess or channel 2210 on its outer surface 2104. Channel 2110 preferably extends substantially around the periphery of the cylindrical outer surface 2104. Firefighting accessory 2000 further includes connector formations 2300 for connecting the firefighting accessory to a source of fire extinguishing agent such as a fire hose or the like. Firefighting accessory 2000 further includes nozzle 2400 that in use extends through the access facilitation conduit into the compartment.

In the embodiment of the firefighting accessory 2000 shown in FIG. 47, the firefighting accessory includes a cutting accessory in the form of a cylindrical cap 2500. Cap 2500 preferably extends over the nozzle, although this need not necessarily be the case. C 2500 has a diameter that corresponds loosely to the inner diameter of the passage through the access facilitation conduit. The cutting accessory is provided for facilitating the cutting of the primary rupturable membrane 6200. To this end, the cap 2500 is provided with sharpened peripheral outer edge 2510 that will shear the rupturable membrane 6200 as the firefighting accessory 2000 is pushed through the passage through the access facilitation conduit. It is envisaged that once the nozzle has been pushed through into the compartment, and the fire extinguishing agent has been pressurised, this will blow the cap 2500 off of the nozzle.

As firefighting accessory 2000 moves into the inner annular member 7710, the channel 2110 will align with the tapered apertures 7716. The spring bias of the outer sleeve 7720 will cause outer sleeve to push the ball bearings 7730 into their seated position when alignment with the channel 2110 provides sufficient space for the ball bearings to move into their seated position. Once the ball bearings 7730 move to their seated position, outer sleeve 7720 is able to move to its locked position in which the ball bearings 7730 not able to move out of their seated position. In their seated position, the ball bearings are received into channel 2110, and prevent retraction of the annular member 2100 from the inner annular member 7710.

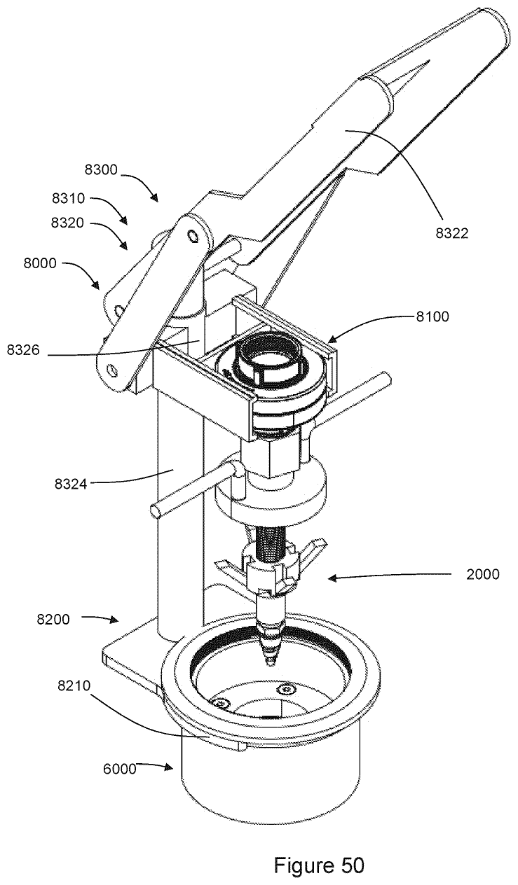

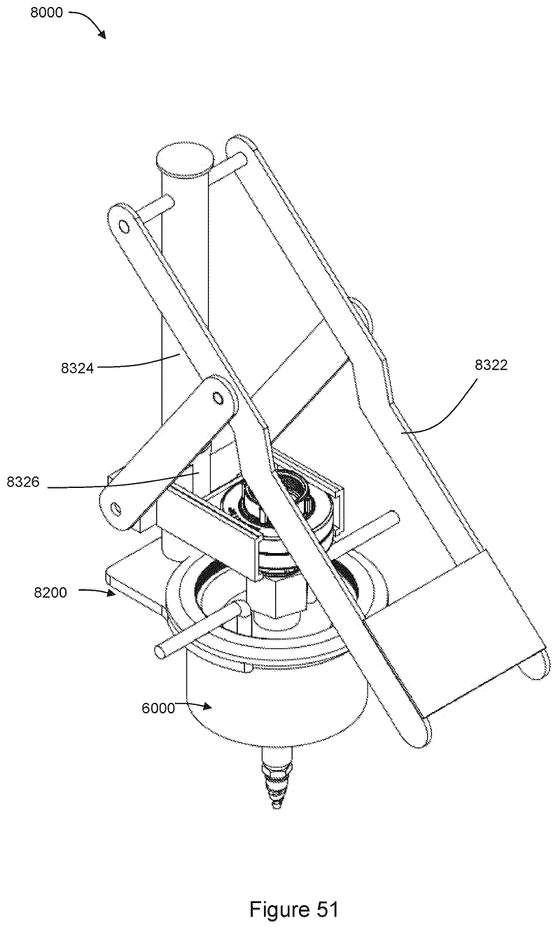

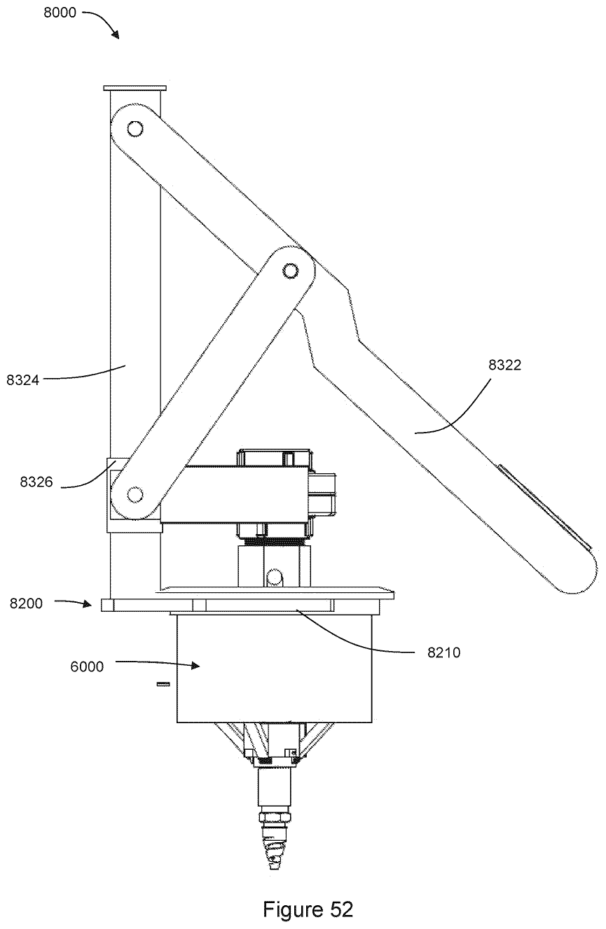

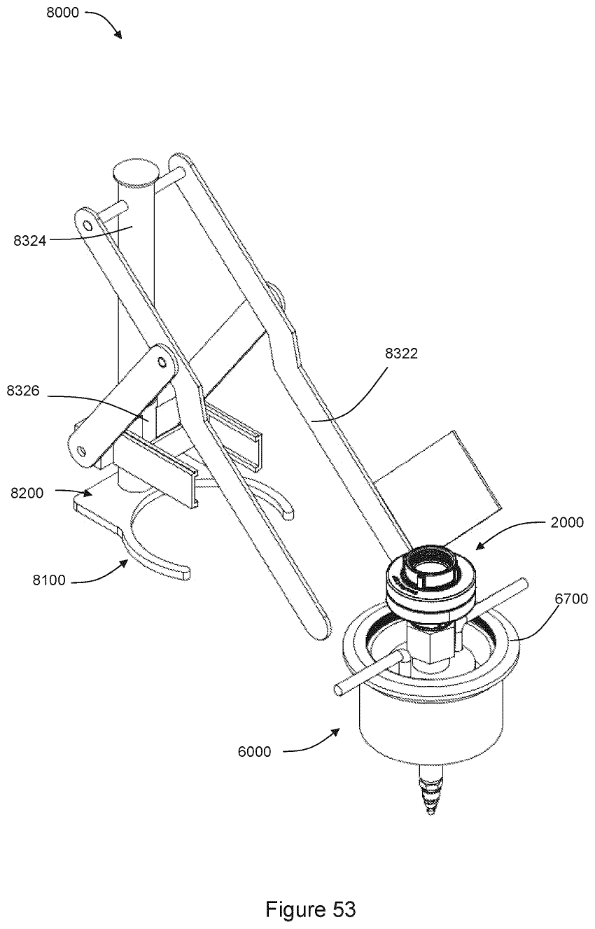

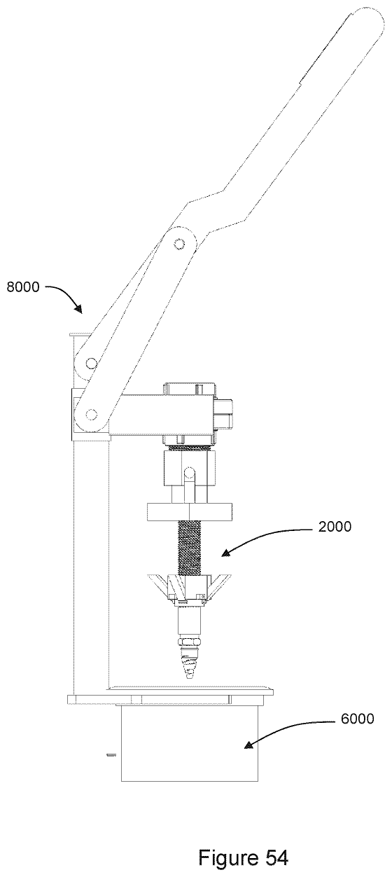

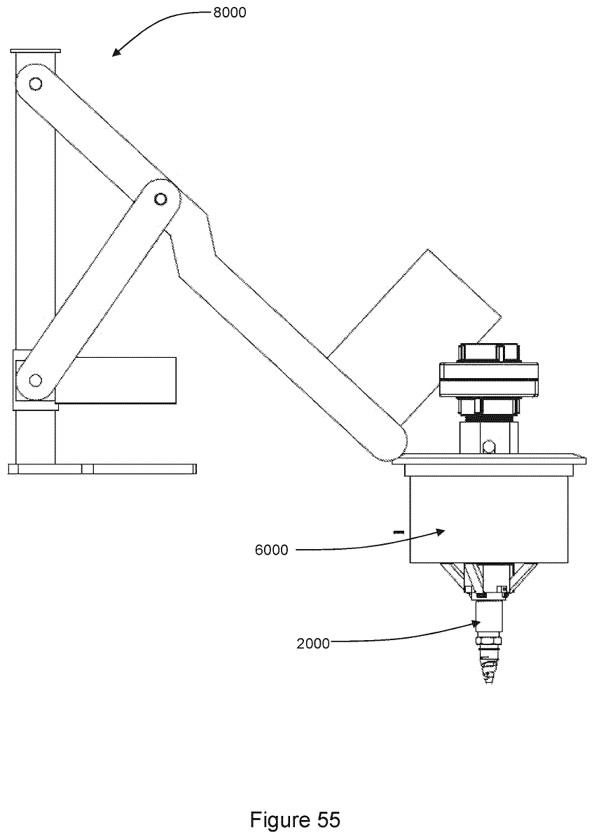

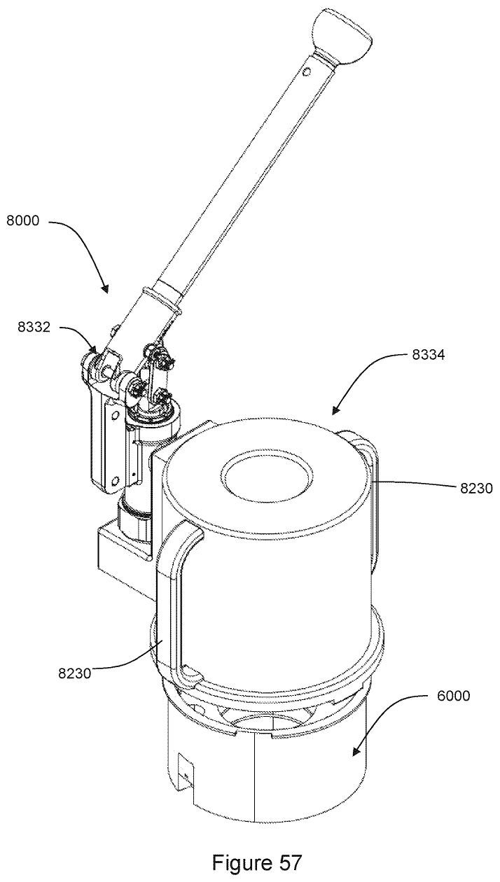

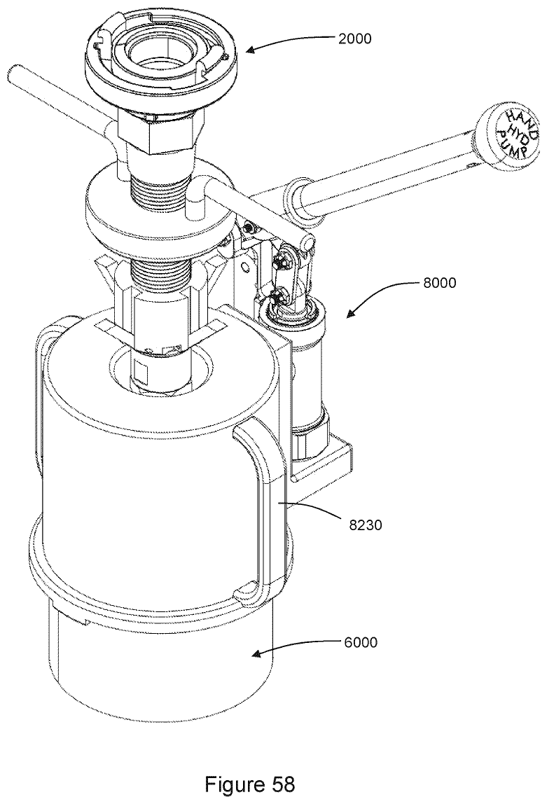

In a further aspect, shown in FIGS. 50-59 it is envisaged that primary rupturable membrane 1200 will be very tough to rupture as it is designed for high pressures and to be leakproof in the event of water ingress into the compartment. For this reason, a disc penetration assistance mechanism 8000 is provided for penetrating the burst disc or rupturable membrane on the access facilitation conduits disclosed.

The penetration assistance mechanism 8000 includes a firefighting accessory connecting formation 8100. The firefighting accessory connecting formation 8100 is adapted for engaging with a firefighting accessory to facilitate it penetrating through a rupturable membrane. This may be by guiding the firefighting accessory once the rupturable membrane has been ruptured, or by pushing the firefighting accessory through the rupturable membrane.

The penetration assistance mechanism 8000 further includes a base 8200 that is configured for secure connection to either an access facilitation conduit, or to the barrier of the compartment itself, or both. To this end, base 8200 preferably includes base connecting formations 8210 that allow it to be connected to either the access facilitation conduit, the barrier, or both. In the embodiments shown in FIGS. 50-55, the penetration assistance mechanism 8000 includes base connecting formations 8210 in the form of a recessed flange that is configured for being mounted to complementary connecting formations on the deck box or access facilitation conduit 6000 in the form of a lip 6710 to secure the penetration assistance mechanism 8000 in place while it facilitates penetration of the rupturable membrane by the firefighting accessory 2000.

It is envisaged in alternative embodiments (not shown) that the base 8200 can be magnetic, use adhesives, thread formations or fasteners to secure the penetration assistance mechanism to the barrier and/or the deck box in preparation for facilitating the penetration of the rupturable membrane.

The penetration assistance mechanism 8000 further includes a force application mechanism 8300. The force application mechanism 8300 is configured for pushing the firefighting accessory at least partially through a rupturable membrane of the deck box; and/or rupturing the rupturable membrane to allow access by the firefighting accessory through the rupturable membrane. The force application mechanism 8300 can further act as a force multiplier mechanism 8310 by multiplying a force or pressure to it to facilitate movement of the firefighting accessory through the rupturable membrane.

In the embodiment shown in FIGS. 50-55, the force application mechanism is a force multiplier mechanism 8310 configured for multiplying force applied to the force multiplier mechanism to push the firefighting accessory at least partially through a rupturable membrane of the access facilitation conduit and/or rupture the rupturable membrane itself.

Preferably the penetration assistance mechanism 8000 is configured for rupturing both a primary rupturable membrane and a secondary rupturable membrane as disclosed above.

In the embodiment shown in FIGS. 50-55, the multiplier mechanism 8310 is in the form of a lever mechanism 8320 and includes a lever 8322 mounted to a post 8324. The lever is connected to a mount 8326 slidable on the post 8324. The mount is configured for engaging with firefighting accessory 2000 to push the firefighting accessory 2000 through the rupturable membrane. The firefighting accessory 2000 can include a cutting accessory or cutting cap 2500 as described above. Force applied downwardly to the lever 8322, for example by manual operation of the lever, will be multiplied in the leverage ratio to facilitate movement of the firefighting accessory 2000 through the rupturable membrane.

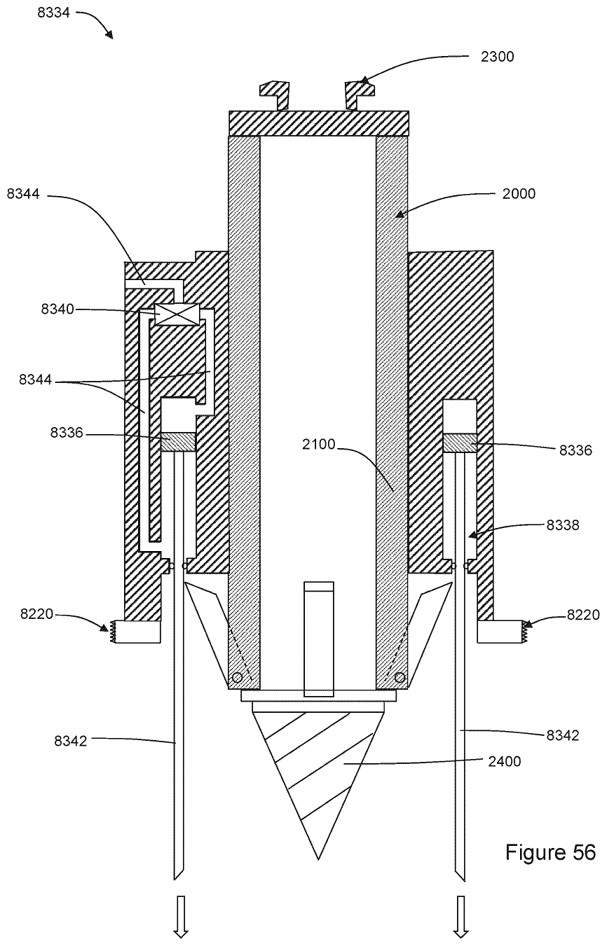

In the embodiment shown in FIGS. 56-58, the force application mechanism 8300 is in the form of a hydraulic force multiplier mechanism 8330. The force application mechanism 8300 includes a hydraulic pump 8332 and a hydraulically operable cutting arrangement 8334. Hydraulic pumps 8332 are well known in the art and will not be described any further.

As shown in FIG. 56, the cutting arrangement 8334 includes an annular piston 8336 reciprocally movable in an annular cylinder arrangement 8338, a valve 8340, and an annular cutting blade 8342 mounted on the piston 8336 for reciprocal movement with the piston 8336. Valve 8340 can be used to select whether the blade is to be moved upward or downwardly with the piston 8336 by selecting which side of the piston hydraulic fluid is diverted to from the hydraulic pump 8332 via passages 8344. Threaded connector formations 8220 are provided for connecting the cutting arrangement 8334 to complementary thread formations on the access facilitation conduit using handles 8230.

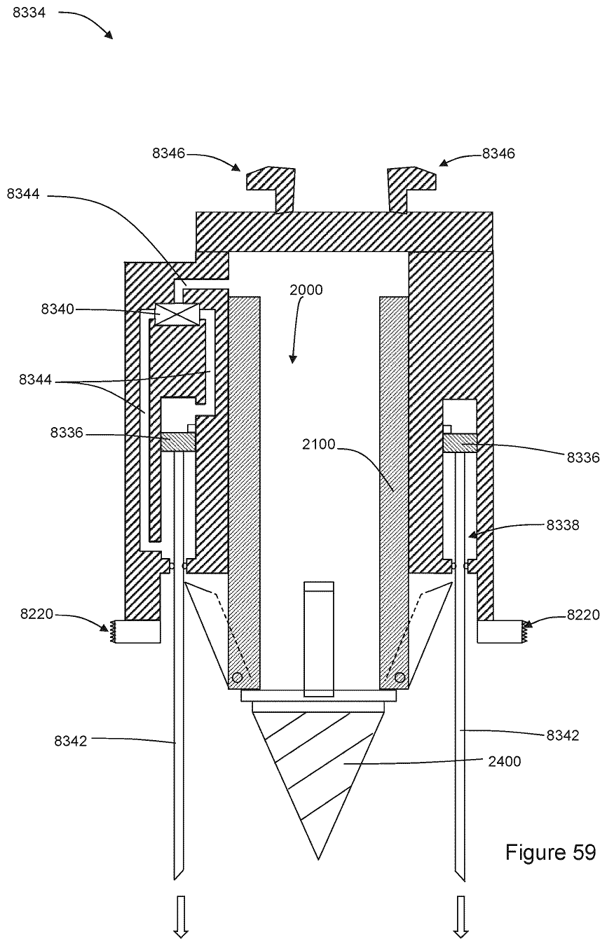

In another embodiment shown in FIG. 59, the force application mechanism 8300 utilises the hydraulic pressure of the firefighting agent to both drive a blade through the rupturable membrane, and to push the firefighting accessory 2000 through the ruptured rupturable membrane so that the nozzle extends into the compartment. The cylindrical

As may be seen in FIG. 59, the force application mechanism includes a cutting arrangement 8334, and including an annular piston 8336, annular cylinder arrangement 8338, valve 8340 and annular cutting blade 8342 similarly to the embodiment shown in FIG. 56. However, in this embodiment, the passages 8344 are not configured to receive pressurised fluid from a hydraulic pump like the embodiment shown in FIG. 56. Instead, the passages 8344 are configured for receiving pressurised fire extinguishing agent from a pressurised source of fire extinguishing agent, such as a fire hose, and utilising it to drive the movement of the annular piston 8336.

In this embodiment it is envisaged that the cutting arrangement may be connected directly to the source of fire extinguishing agent such as a fire hose, and includes connector

Simultaneously, pressure of the pressurised fire extinguishing agent acting on the rear of the firefighting accessory 2000 will drive the firefighting accessory through the rupturable membrane of the access facilitation conduit and into the compartment.

It will be appreciated that the provision of the cutting arrangement 8334 may not be necessary if the firefighting accessory 2000 can be driven with enough force to rupture the rupturable membrane, and without damaging the firefighting accessory.

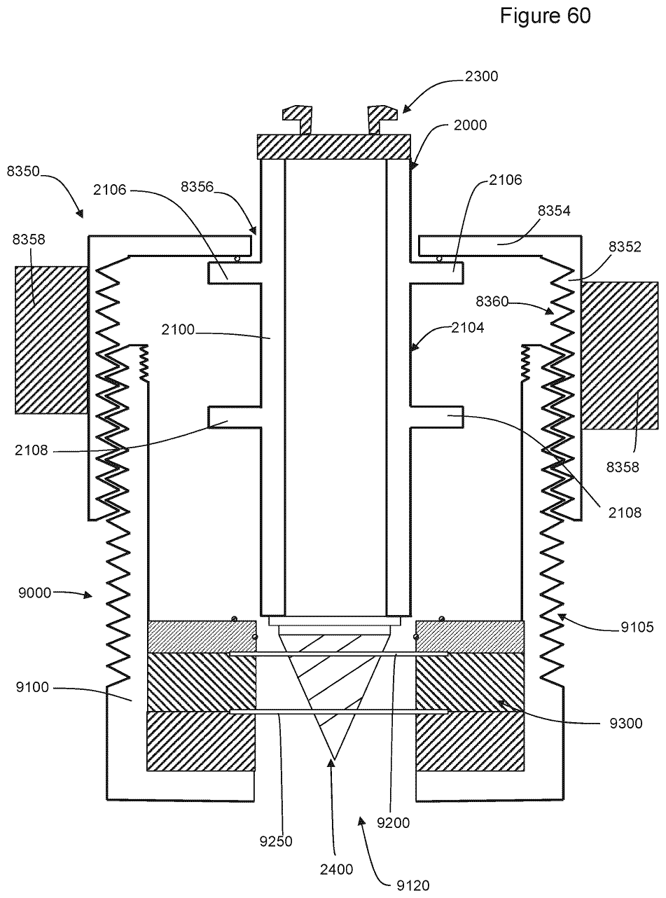

In FIG. 60, a further embodiment of an access facilitation conduit 9000 is shown that is intended to be used with a threaded mechanical force application mechanism 8350 and a firefighting accessory 2000. The access facilitation conduit 9000 includes a cylindrical frame 9100, a primary rupturable membrane 9200, a secondary rupturable membrane 9250, a clamping arrangement 9300 defining a passage 9120 and is generally similar to clamping arrangement 6000 disclosed above. The access facilitation conduit 9000 further includes an outwardly facing, preferably course thread formation 9105 on an outer surface of the cylindrical frame.

The mechanical force application mechanism 8350 includes a cylindrical body 8352 extending to a radial flange 8354 at a distal end. Radial flange 8354 defines a central aperture 8356, which is adapted for receiving the firefighting accessory 2000.

Firefighting accessory 2000 includes an annular body member 2100 defining an inner surface 2102 and an outer surface 2104. A pair of radially extending flanges 2106, 2108 are provided on outer surface 2104. The diameter of the radially extending flanges 2106, 2108 are greater in diameter than the inside diameter of the central aperture 8356, and of the passage 9120, respectively.

Coarse thread formations 8360 that are complementary to the thread formation 9105 of the access facilitation conduit 9000 are provided on an inner face of the cylindrical body 8352. When the thread formations are turned relative to each other, this will move the cylindrical body 8352 axially upwards or downwards, depending the direction of turning. Handles 8358 are provided for turning the cylindrical body 8352 to tighten or release the thread formations.

Movement of the cylindrical body 8352 downwardly in FIG. 60 will cause the abutment of the radial flange 8354 with radially extending flange 2106, to thereby cause the firefighting accessory 2000 to move downwardly through the passage 9120, while rupturing the primary rupturable membrane 9200 and secondary rupturable membrane 9250 and entering the compartment. Movement of the firefighting accessory into the compartment will continue until radially extending flange 2108 makes contact with an upper surface of the clamping arrangement 9300.

The firefighting accessory 2000 is further configured for direct connection to a source of fire extinguishing agent, such as a fire hose via connector formations 2300.

Advantages will now be described below.

Advantageously, the access facilitation conduits described above provide convenient and timely access to the compartment through a bulkhead in order to fit and operate a fire extinguishing device.

In addition, an access facilitation conduit is shown can provide electrical insulation from the compartment wall of bulkhead while a fire extinguishing device is being set up for operation. This allows for improved safety, time savings in time critical situations, and ease of use when extinguishing a fire within a compartment on a sea going vessel, or within an electrical compartment.

The access facilitation conduits described above obviate the need to drill a hole through steel and then insert a firefighting hose through the drilled hole.

In addition, the access facilitation conduits described will further provide information that may be valuable in the management of a fire, such as temperatures, an early warning of a high-pressure event such as an explosion, and the like.

Further, the access facilitation conduit, in combination with the penetration assistance mechanisms, and the firefighting accessories disclosed will facilitate the penetration of the access facilitation conduit by the firefighting accessory.

### Interpretation

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

For the purposes of this specification, the term “plastic” shall be construed to mean a general term for a wide range of synthetic or semisynthetic polymerization products, and generally consisting of a hydrocarbon-based polymer.

As used herein the term “and/or” means “and” or “or”, or both.

As used herein “(s)” following a noun means the plural and/or singular forms of the noun.

### Combinations of Features in Embodiments

Different features are described in different embodiments in this specification, however it is envisaged that any features shown in any embodiment described may be used with any other features in any other embodiment in any combination, unless this is not logically possible.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### SCOPE OF INVENTION

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the naval and firefighting industries.

1-26. (canceled)

27. An access facilitation conduit suitable for allowing access by a firefighting accessory through an aperture in a barrier at least partially surrounding a compartment, the access facilitation conduit comprising:
a. a frame adapted to be mounted within the aperture of the barrier, the frame defining a passage therethrough; and
b. an agent connector arrangement configured for connection to a source of fire extinguishing agent to thereby allow a flow of fire extinguishing agent through the passage; and
c. a cover retainable by the frame to seal the passage, the cover being removably attachable to the frame from outside of the compartment to allow access to the connector arrangement; and
d. a rupturable membrane retainable by the frame to at least partially cover the passage, the rupturable membrane being configured for being ruptured to access the passage.

28. The access facilitation conduit of claim 27, wherein the rupturable membrane is configured for being ruptured by engagement of the firefighting accessory with the access facilitation conduit.

29. The access facilitation conduit of claim 27, wherein the access facilitation conduit includes a nozzle arrangement configured for extending through the aperture in the barrier.

30. The access facilitation conduit of claim 27, wherein the access facilitation conduit includes a connector arrangement for connecting to a source of fire extinguishing agent.

31. The access facilitation conduit of claim 27, wherein the access facilitation conduit includes a frame connecting arrangement configured for connecting the frame to the barrier.

32. An access facilitation conduit for allowing access by a firefighting accessory through an aperture in a barrier at least partially surrounding a compartment, the access facilitation conduit comprising:
a. at least one or more electrically insulative body members defining a passage therethrough, the at least one or more insulated body members being configured for receiving fire extinguishing agent to thereby allow a flow of fire extinguishing agent through the passage; and
b. a retaining arrangement adapted to attach to the body member and securely mount the body member within the aperture of the barrier.

33. The access facilitation conduit of claim 32, wherein the access facilitation conduit includes a rupturable membrane retainable by the insulated body member to at least partially cover the passage, and wherein the rupturable membrane is configured for being ruptured to access the passage.

34. The access facilitation conduit of claim 32, wherein the body member is configured for connection to a source of fire extinguishing agent.

35. The access facilitation conduit of claim 32, wherein the body member includes an outer insulative piece and an inner insulative piece.

36. The access facilitation conduit of claim 32, wherein the retaining arrangement includes an inner retaining member and an outer retaining member.

37. The access facilitation conduit of claim 36, wherein the retaining arrangement includes a body retaining member configured for retaining the body member in position together with the outer retaining member.

38. The access facilitation conduit of claim 36, wherein the inner retaining member and outer retaining member are configured for attachment to each other through the aperture.

39. The access facilitation conduit of claim 35, wherein the inner insulative piece and the outer insulative piece each include an engaging formation configured to engage a complementary engaging formation on the body retaining member and outer retaining member, respectively.

40. The access facilitation conduit of claim 37, wherein the body member includes an outer insulative piece and an inner insulative piece, wherein the access facilitation conduit includes a rupturable membrane retainable by the insulated body member to at least partially cover the passage, and wherein the body retaining member and the outer retaining member act to clamp the inner insulative piece and the outer insulative piece together to retain the rupturable membrane.

41. A penetration assistance mechanism for penetrating a rupturable membrane on an access facilitation conduit, the penetration assistance mechanism comprising:
a. an accessory connecting formation adapted for engaging with a firefighting accessory for penetrating through a barrier to access a compartment in which a fire may be present;
b. a base configured for secure connection to one or more selected from the access facilitation conduit and the barrier;
c. a force application mechanism including a mechanical force multiplier mechanism configured for applying force to carry out one or more selected from:
i. pushing the firefighting accessory at least partially through the rupturable membrane of the access facilitation conduit; and
ii. rupturing the rupturable membrane to allow access by the firefighting accessory through the rupturable membrane;
d. and wherein the mechanical force multiplier mechanism includes one or more selected from a lever and a threaded formation.

42. A penetration assistance mechanism of claim 41, wherein the base includes connecting formations configured for mounting the penetration assistance mechanism to complementary connecting formations on the access facilitation conduit.

43. A penetration assistance mechanism of claim 41, wherein the mechanical force multiplier mechanism is configured for translating helical movement along a thread formation to axial movement.
